(19) United States
(12) Patent Application Publication
(10) Pub. No.: US 2003/0130931 A1
(43) Pub. Date: Jul. 10, 2003

(54) System, method, and apparatus for implementation and use of a trading process on a data processing system

(75) Inventors: Lev Mirlas, Thornhill (CA); Howard C. Borenstein, Downsview (CA); Victor S. Chan, Thornhill (CA); Lai Shan Cecilia Chan, Scarborough (CA); Raymond K.M. Kwok, Willowdale (CA); Glen Shortliffe, Toronto (CA)

Correspondence Address: David A. Mims, Jr., IBM Corporation, Intellectual Property Law Department, 11400 Burnet Road, Austin, TX, 78758, US

(73) Assignee: International Business Machines Corporation, Armonk, NY

(21) Appl. No.: 10/286,921

(22) Filed: Oct. 31, 2002

(30) Foreign Application Priority Data
Nov. 30, 2001 (CA) 2,364,068

(51) Int. Cl. G06F 17/60

(52) U.S. Cl. 705/37

(57) ABSTRACT

The invention described herein provides a method, apparatus, and software for implementing a unified trading structure for use in a computerized trading system that implements trading relationship mechanisms for participant roles, including: selecting a set of characteristics which are common to a plurality of trading relationship mechanisms; the characteristics including: identifying participants for each participant role, terms and conditions that apply to all or selected participants, a description of the relationship, storing the characteristics. Preferably the method may include at least one attachment, which is stored, storing the characteristics, and the at least one attachment. The characteristics of the attachment may include Uniform Resource Information: mime type; and optional content.

### FIELD OF THE INVENTION

This invention relates to the conduct of electronic commerce and more particularly with the computerized representation and execution of a trading process that takes advantages of the use of business policies and procedures for simplifying the conduct of business activities, for instance in the development of RFQs, contracts, accounts and other trading devices, structures, or mechanisms used in electronic commerce.

### BACKGROUND OF THE INVENTION

Business enterprises have developed their own methods of achieving their business goals, even within a particular region or industry. They have created processes and implemented manual systems and computer systems to achieve these goals. As these systems were evolving, enterprises encoded them with bits and pieces of their business policies or “rules”, used to determine the processes implemented by each particular system and control their workflow.

In other words, most business enterprises have scattered or fragmented business policy rules implemented in more than one computer or system, which are connected electronically, or more frequently manually, to achieve the overall enterprise process workflow. Changing an enterprise practice or policy thus often requires amending many application systems, and hence disturbing the workflow balance.

The implementation of business policies occurs in every aspect of the operation of a business. This applies both internally, to processes which the business relies upon for its internal activities workflow, and externally, for example, in the preparation and negotiation of a contract and then in conducting the contractual activities with other partners.

The commercial contract has evolved as a means of developing an ongoing business trust and loyalty between business collaborators. A contract expresses an agreement between trading partners for the execution of contractual activities. Most often the contractual activities will be commercial in nature, however a contract can also be used to govern the conduct of parties in non-commercial activities. The contract becomes the parties' reference in the execution of such activities, as well as legal evidence of the intention of the parties which governs any dispute regarding the activities.

The scattered or fragmented business policy rules under which most business systems operate can present significant administrative problems for an organization executing activities using hundreds or thousands of such policy rules. Internally, organizations may have many levels and departments which have to work together in a cooperative and integrated fashion in order for the business to run efficiently and effectively. Externally, conducting trading with another enterprise, either directly or through an e-marketplace, requires sharing and integrating business processes from both sides as well as sharing some policy rules and data to change or control the process workflow at the collaborating partner's side. Since such information neither originates from nor targets one central system, more integration points and cumbersome technological methods are required to achieve an effective enterprise-to-enterprise business processes molding.

This problem of fragmented business policy is further compounded by the existence of multiple methods of conducting business. Buyers may create transactions with sellers by purchasing based on a published fixed price, or based on a contract, or through bidding on an auction, or as a result of a Request For Quotation (RFQ) process; and there are a number of other frequently used mechanisms for conducting trading activities. Each one of these mechanisms must be managed by the seller for a customer, including the business policies that the trading process must enforce, and any customer specific customizations that are applied to the process.

Canadian Patent Application 2,324,729, IBM docket CA9-2000-0068, System and Method for Representation of Business Policy and Governing the Conduct of Business Activities Using a Business Rules Book discloses a system and method for the representation of business policy and the governing of business activities using a centrally stored Business Rules Book (BRB). According to that patent application, a Business Rules Book maintained by an organization contains a set of policy and procedural rules governing most aspects of the organization's internal and external activities. The organization maintains a plurality of stored Policy Sets, each representing a unique set of rules and policy instances selected from the Business Rules Book. The organization establishes the policy and procedural rules under which the various levels and departments in the organization operate internally and also, the trading and collaboration business activities are conducted, using selected Policy Sets designed to address policy and procedural parameters set for each specific user, group, or trading and collaborating partner. Policy Sets can be incorporated into business contracts when conducting collaborative activities with external partners.

The abovementioned application discloses a preferred embodiment in which the organization creates an information asset repository that contains links to all or relevant digitized contents that are needed to run the business activities internally or externally. Access to such an information asset repository is controlled using a resource access tool or a directory service like, for example, an LDAP (Lightweight Directory Access Protocol) Directory Service.. The Business Rules Book, Policy Set and optionally a representation form of an information asset repository are linked in a business contract, to create a centrally stored codification of all business policies and procedures, customized to each level and department within the organization and each contracted business deal with collaborating parties.

Business activities are executed through the Policy Set as a conduit, which automatically inserts parameter values and other information assets from data profiles and content repository. Therefore, absolute conformity with the terms and constraints of the Policy Set is maintained for each internal and external business activity undertaken by the organization, and manual administrative activities designed to enforce compliance with the organization's policies and procedures are minimized. Moreover, only those individuals and organizations with proper access privileges within the Policy Set can participate in executing the designated activities.

The Business Rules Book can potentially form the central processes repository and enterprise governor for all industry- or business-specific rules and practices. The invention of the abovementioned patent application offers granular components that can be easily customized to support different business models or workflows, and allows flexible access control of the generated entities, such as Policy Instances and Policy Sets.

The system and method of the invention of the abovementioned patent application de-fragments and centrally stores all of a business enterprise's policies and rules, which facilitates the implementation of changes within an organization and enhances the efficiency of integration of two or more trading enterprises into a business arrangement. The system and method according to the invention also provides means for facilitating a management control chain through the hierarchy of business personnel, allowing each level of personnel to deal with enhancement to and modification of systems within their respective core competency, while limiting access at each level to the responsible department or personnel.

The invention of the abovementioned patent application thus provides a system for generating a representation of business policy, comprising a computer for: storing at least one compilation of business rules comprising a plurality of rules available to be selected for inclusion in a business contract, storing at least one policy set containing parameters corresponding to selected rules from the compilation of business rules, generating links between the compilation of business rules and the policy set to generate specific rules to be embodied in the business contract, and interlocking the compilation of business rules, the policy set and the links.

The invention of the abovementioned patent application further provides a method of generating a representation of business policy, comprising the steps of a. storing at least one compilation of business rules comprising a plurality of rules available to be selected for inclusion in a business contract, b. storing at least one policy set containing parameters corresponding to selected rules from the compilation of business rules, c. generating links between the compilation of business rules and the policy set to generate specific rules to be embodied in the business contract, and d. interlocking the compilation of business rules, the policy set and the links.

Further aspects of the system and method of the invention of the abovementioned patent application generating a representation of business policy include: storing at least one product list filter for generating a list of a specified subset of products from a master list of products, and generating links between the product list filter, the policy set and the master list of products; the products list filter comprises a plurality of tiers, each tier generating a list of a different subset of products; the contract comprises dynamic elements which can be altered without modifying the business contract; the products list filter is a dynamic element; and/or the business contract is locked after interlocking contract elements and links.

Further aspects of the system and method of the invention of the abovementioned patent application generate a representation of business policy include generating links between the policy set and a repository of enterprise static and dynamic contents. This repository includes, for example, products catalog, documents, web pages, and transactional records. The policy set interlocks business rules with enterprise contents and users and organizations profiles. It also provides the capability to lock this combination to preserve the integrity and accessibility of involved processes and contents.

While the invention of the abovementioned patent application has made significant advances in the conduct of electronic commerce, there still remain considerable complexity in developing systems capable of simplifying the generation of trading instruments/processes/structures/mechanisms.

There also remains a need to specify the structure of the business policy rules and interfaces, as well as define specific policies that are needed to encapsulate the trading business process.

Canadian Patent Application 2,322,602, SYSTEM AND METHOD FOR GENERATING A CONTRACT AND CONDUCTING CONTRACTUAL ACTIVITIES UNDER THE CONTRACT discloses a system and method for generating and recording a contract and for carrying out contractual activities between contracting parties within parameters set by the contract.

The invention disclosed in IBM application 2,322,602 provides a system and method for automating the contract negotiation and preparation cycle, and for electronically facilitating subsequent contractual activities executed pursuant to the contract. According to the invention disclosed in IBM application 2,322,602, a system is provided for generating a contract between a seller and a buyer comprises a Business Rules Book (BRB) maintained by an administering organization, for example the seller, containing a set of rules from which specific rules may be selected for inclusion in the contract. The seller selects a Terms and Conditions Set from a plurality of stored Terms and Conditions Sets, each representing a unique set of Instances of rules selected from the Business Rules Book. The seller and the buyer settle the provisions of the contract by agreeing to a mutually acceptable Terms and Conditions Set.

In the preferred embodiment of the invention disclosed in IBM application 2,322,602 the buyer conveys product needs to the seller, from which the seller creates a Product List Filter specific to the buyer that targets only those products in which the buyer has expressed an interest. The Business Rules Book, Terms and Conditions Set and Product List Filter are linked in a contract profile, to create a contract representing the agreement between the seller and the buyer, and the contract is locked to prevent unilateral amendment by either party.

In a buy-side embodiment, where the buyer is the administering organization, the buyer selects a Terms and Conditions Set from a plurality of stored sets of Terms and Conditions Sets, for example in a tender for bidding by suppliers. The buyer can create a Product List Filter specific to each seller that targets only those products which the seller will be engaged to supply. When an agreement is reached the elements of the contract are linked and locked as described above. Subsequent contractual activities under the contract are executed through the contract as a conduit, which automatically inserts values from the parameters in the contract.

The contract preparation and negotiation system and method according to the invention disclosed in IBM application 2,322,602 takes advantage of the wide reach of the Internet to automate contract creation and accelerate the contract negotiation cycle. A contract created according to the invention disclosed in IBM application 2,322,602 gives trading organizations a well defined and shared entity to control and monitor their business relationship. The Business Rules Book, Terms and Conditions and Product List Filters are flexible and extendible, offering selling and buying organizations considerable versatility, improving the efficiency of the contract negotiation process, and, unlike other automated contract generation systems, allowing contract revision and upgrading to be managed by an administrator rather than a computer programmer, and also allowing a business person, rather than a computer programmer, to drive business policy. It also reduces buyer and seller administrative overhead and reduces overall transaction cost, and allows for a one-to-one marketing and business relationship with unlimited number of trading organizations. The Business Rules Book can potentially form the central repository and enterprise governor for all industry- or business-specific rules and practices. In the preferred embodiments the invention disclosed in IBM application 2,322,602 offers granular components that can be easily customized to support different business models or workflows, and allows flexible access control of the generated entities, such as Terms and Conditions and Product List Filters.

The system and method of the invention disclosed in IBM application 2,322,602 de-fragments and centrally stores all of a business enterprise's rules, policies and procedures, which facilitates the implementation of changes within an organization and enhances the efficiency of integration of two or more trading enterprises into a business arrangement. It also provides means for facilitating a management control chain through the hierarchy of business personnel, allowing each level of personnel to deal with enhancement to and modification of systems within their respective core competency, while limiting access at each level to the responsible personnel.

The invention disclosed in IBM application 2,322,602 thus provides a system for generating a contract between at least one seller and at least one buyer, comprising a computer for: storing at least one compilation of business rules comprising a plurality of rules available to be selected for inclusion in the contract, storing at least one terms and conditions set containing parameters corresponding to selected rules from the compilation of business rules, generating links between the compilation of business rules and the terms and conditions set to generate specific terms and conditions to be embodied in the contract, and interlocking the compilation of business rules, the terms and conditions set and the links to lock the contract.

In further aspects of the invention disclosed in IBM application 2,322,602 a computer stores at least one product list filter for generating a list of a specified subset of products from a master list of products, and generates links between the product list filter, the terms and conditions set and the master list of products; the product list filter comprises a plurality of tiers, each tier generating a list of a different subset of products; the contract comprises dynamic elements which can be unilaterally altered by either the seller or the buyer; the product list filter is a dynamic element; and/or the contract is locked by the implementation of digital signatures.

In further aspects of the invention disclosed in IBM application 2,322,602 a communications interface displays selected information based on terms and conditions in the contract; and/or the contract is provided with representation criteria comprising product selection criteria or products exclusion criteria, or both, wherein the communications interface displays to the buyer a filtered products list comprising a subset of products from a master product list.

The invention disclosed in IBM application 2,322,602 does not address the detailed structure of a contract, and furthermore does not describe a complete set of terms and conditions that are necessary to describe a contract. Also, the invention disclosed in IBM application 2,322,602 only describes the generation and operation of a contract, but does not address other trading mechanisms.

Trading Mechanisms

The general notion of ‘trading’ includes a number of different mechanisms for transactions that either involve, or may lead to, the exchange of goods or services for either money or for other goods or services (the latter is known as barter). A number of the terms for these mechanisms will be recognizable by those familiar with the flow of business transactions and accounting.

Examples of Trading Mechanisms

A ‘fixed price’ mechanism refers to the common shopping process typically used at retail in North America, where buyers purchase goods or services for a predetermined price, set or determined by a store. Besides the price, the store typically imposes other rules, such as refund/exchange policies, shipping rules and charges, payment rules, etc.

A ‘contract’ mechanism refers to an arrangement in which an individual buyer or group of buyers may purchase products using a pre-negotiated set of terms and conditions, that determine the products covered, prices, shipping rules, returns/exchange rules, payment rules, etc.

An ‘RFQ’ (Request for Quotations) mechanism refers to a negotiating process in which a potential buyer puts out a specification of needs, and potential seller(s) respond with their proposals. The RFQ specification may include a list of items, with descriptions, requested prices, shipping rules, payment terms, etc. Typically the response(s) to the RFQ, if any, may indicate counter-proposal(s) of the requested terms, perhaps adding other terms. The negotiation may take several rounds, with the potential buyer re-issuing the request, and potential sellers responding, until the buyer evaluates the response(s), and accepts one or some combination of them.

Contract: The result of an RFQ Process may be either a contract or a one-time order.

An ‘Auction’ is a trading mechanism in which a seller offers a product, or a set of products, for sale to the highest bidder. Potential buyers submit their bid prices. At the auction closing time, the highest bid price is selected as the winning bid.

A ‘Reverse Auction’ is a trading mechanism in which a buyer indicates that he is looking for a product, or a set of products. Potential sellers then submit their bid prices. At the reverse auction closing time, the lowest bid price is selected as the winning bid.

An Account(sometimes referred to as a business account): Some aspects of the purchasing or trading process may be controlled, not by the trading mechanisms as described above, but may be determined by the relationship between the buyer and the seller. We call this relationship a ‘business account’, or simply ‘account’. Examples of the aspects of the business process set by an account are:

Invoice customization, including invoicing period, invoice delivery method, and invoice appearance (look&feel)

Purchase Order verification

Maintenance a buyer's line of credit with the seller

We thus have seen a number different mechanisms or factors that affect the trading processes, and that require the capture of business information (e.g. prices).

A computer system that implements trading processes will find it advantageous to implement all these mechanisms. At the same time, it is not unlikely that a single chain of business transactions may involve a number of trading mechanisms. For example, an RFQ negotiation may lead to the creation of a contract; the order placed under a contract may be processed under the auspices of an account.

### SUMMARY OF THE INVENTION

In this invention, we define a structure called ‘Trading’ to represent the common features of the different trading mechanisms.

The invention herein seeks to:

Provide a common ‘Trading’ structure that may be used by a trading system to carry out the trading process in accordance with the required rules;

Describe a specific set of trading components (such as Terms and Conditions), that constitutes a Contract, or an RFQ;

Describe a specific set of trading components (such as Terms and Conditions) that constitutes a Business Account;

Introduce and describes the notion of a Business Policy, used by the trading Terms and Conditions; and,

Describe a specific set of Business Policy types that may be used by a trading system.

The foregoing aspects of the invention, together with other aspects and advantages thereof will be more apparent from the following description of the preferred embodiments thereof, taken in conjunction with the drawings.

One aspect of the invention provides a method for implementing a unified trading structure for use in a computerized trading system that implements trading relationship mechanisms for participant roles, including:

selecting a set of characteristics which are common to a plurality of trading relationship mechanisms

the characteristics including:

identifying participants for each participant role,

terms and conditions that apply to all or selected participants,

a description of the relationship,

storing the characteristics.

Preferably the method may include at least one attachment, which is stored.

The characteristics of the attachment may include Uniform Resource Information: mime type; and optional content.

Another aspect of the invention provides a method for implementing a unified trading structure for use in a computerized trading system that implements trading relationship mechanisms for participant roles, including:

selecting a set of characteristics which are common to a plurality of trading relationship mechanisms, the characteristics including:

identifying participants for each participant role,

terms and conditions that apply to all or selected participants,

description of the relationship,

storing the characteristics;

wherein the identified participants include a set of participants characteristics; and, wherein the set of participant characteristics may include:

a) identification of a participant role,

b) identification of users fulfilling the participant role wherein the users may be individual participants or members of a participant organization that comprises a plurality of individuals or suborganizations or a group of users; and, optionally,

c) a reference to one or more terms and conditions.

The characteristics common to the terms and conditions may include:

a reference to a trading object

a set of parameters

references to one more business policies such as a payment methods, qualifications, pricing formula

type and a subtype.

Another aspect of the invention provides a method for implementing a unified trading structure for use in a computerized trading system applying business policies of participants using the trading system that implements trading relationship mechanisms for participant roles, including:

selecting a set of characteristics which are common to a plurality of trading relationship mechanisms

the characteristics including:

identifying participants,

terms and conditions that apply to all or selected participants,

description of the relationship,

storing the characteristics;

wherein the identified participants include a set of participants characteristics; and, wherein the set of participant characteristics may include:

a) identification of a participant role,

b) identification of users fulfilling the participant role wherein the users may be individual participants or members of a participant organization that comprises a plurality of individuals or suborganizations or a group of users; and, optionally,

c) a reference to one or more terms and conditions,

d) a reference to a trading object;

wherein the characteristics common to the terms and conditions include:

references to one more business policies,

a set of trading parameters that may be used to qualify the operation of the business policies; and,

term type and where suitable, a term subtype.

Yet another aspect of the invention provides a method for implementing a unified trading structure for use in a computerized trading system applying business policies of participants using the trading system that implements trading relationship mechanisms for participant roles, including:

selecting a set of characteristics which are common to a plurality of trading relationship mechanisms

the characteristics including:

identifying participants,

terms and conditions that apply to all or selected participants,

description of the relationship,

storing the characteristics;

wherein the identified participants include a set of participants characteristics; and, wherein the set of participant characteristics may include:

a) identification of a participant role,

b) identification of users fulfilling the participant role wherein the users may be individual participants or members of a participant organization that comprises a plurality of individuals or suborganizations or a group of users; and, optionally,

c) a reference to one or more terms and conditions,

d) a reference to a trading object;

wherein the characteristics common to the terms and conditions include:

references to one more business policies,

a set of trading parameters that may be used to qualify the operation of the business policies; and,

term type and a term subtype.

A method is also provided for implementing a unified trading structure for use in a computerized trading system applying business policies of participants using the trading system that implements trading relationship mechanisms for participant roles, including:

selecting a set of characteristics which are common to a plurality of trading relationship mechanisms

the characteristics including:

identifying participants

terms and conditions that apply to all or selected participants

description of the relationship

storing the characteristics;

wherein the identified participants include a set of participants characteristics; and, wherein the set of participant characteristics may include:

a) identification of a participant role,

b) identification of users fulfilling the participant role wherein the users may be individual participants or members of a participant organization that comprises a plurality of individuals or suborganizations or a group of users; and, optionally,

c) a reference to one or more terms and conditions,

d) a reference to a trading object;

wherein the characteristics common to the terms and conditions include:

references to one more business policies,

a set of trading parameters that may be used to qualify the operation of the business policies; and,

a term subtype,

each of the subtypes being grouped with other similar subtypes, if any, into a term type.

According to another aspect of the invention the unified trading structure is applied to trading objects where the trading objects include contracts, RFQ's, auctions, reverse auctions and business accounts.

In another aspect of the invention a method is provided for determining whether a trading relationship mechanism applies to a transaction of a user, including:

Identifying participant roles that are permitted to use the trading relationship mechanism for the transaction;

identifying participants having a set of participant characteristics with the roles in the trading relationship mechanism to which the user belongs,

if none, disallowing the transaction;

if the user belongs to at least one participant with one of the participant roles;

retrieving terms and conditions pertinent to the participants applicable to the transaction and having a set of term characteristics;

wherein the participant characteristics include:

a) identification of a participant role

b) identification of users fulfilling the participant role wherein the users may be individual participants or members of a participant organization that comprises a plurality of individuals or suborganizations or a group of users; and, optionally,

c) a reference to one or more terms and conditions

d) a reference to a trading object, and,

wherein the term characteristics common to the terms and conditions include:

references to one more business policies

a set of trading parameters that may be used to qualify the operation of the business policies; and,

term type and a term subtype.

Another aspect of the invention provides a method for determining whether a trading relationship mechanism applies to a transaction of a user, including:

identifying participant roles that are permitted to use the trading relationship mechanism for the transaction;

identifying participants having a set of participant characteristics with the roles in the trading relationship mechanism to which the user belongs,

if none, disallowing the transaction;

if the user belongs to at least one participant with one of the participant roles;

retrieving terms and conditions pertinent to the participants applicable to the transaction and having a set of term characteristics;

Wherein the participant characteristics include:

a) identification of a participant role,

b) identification of users fulfilling the participant role wherein the users may be individual participants or members of a participant organization that comprises a plurality of individuals or suborganizations or a group of users; and, optionally,

c) a reference to one or more terms and conditions,

d) a reference to a trading object, and,

wherein the term characteristics common to the terms and conditions include:

references to one more business policies

a set of trading parameters that may be used to qualify the operation of the business policies; and,

a term subtype,

each of the subtypes being grouped with other similar subtypes, if any, into a term type.

The identified participant roles may include buyers, sellers, account holders, requesters, and bidders.

The identified participants include a set of participant characteristics.

The set of participant characteristics may include:

a) identification of a participant role,

b) identification of a member of a participant if the participant comprises a plurality of individuals,

c) a reference to one or more terms and conditions,

d) a reference to a trading object.

The characteristics common to a contract may include

identification of participants for the buyer and seller participant roles;

terms and conditions including identification of a set of products and specifications, identification of a set of requested prices,

identification of payment terms including payment method,

identification of shipping terms,

identification of other terms and conditions;

optional reference to a business account, and,

name of contract, a description and documentation attachments as well as a description mapping relationship between specific buyer participants and selected terms and conditions.

Where the contract is an unrestricted contract any buyer is entitled to fulfill a buyer participant role.

Under another aspect of the method of the invention the characteristics common to an RFQ include:

identification of participants for the requester and seller participant roles;

terms and conditions including identification of a set of products and specifications,

identification of a set of requested prices,

identification of payment terms including payment method,

identification of shipping terms,

identification of other terms and conditions;

optional reference to a business account, and,

name of RFQ, a description and documentation attachments as well as a description mapping relationship between specific buyer participants and selected terms and conditions.

The characteristics of a business account trading object may include identification of account holder and seller participants, terms and conditions including invoicing, display customization, and entitlement to unrestricted contracts as well as name of the account, and description (comments) and a documentation attachment.

The trading object may comprise a contract and a process of determining entitlement to use a contract comprises referring to the participant component of a trading object including:

finding all trading object of the type contract;

finding a list of user's parent organizations, commencing with an immediate parent and proceeding to the top level of the organization;

within the set of objects type contract, finding all contracts in which at least one the user's parent organizations located as aforethe is a buyer participant:

within the set of all trading objects of type contract finding all unrestricted contracts which are not restricted to specific buyer participants;

finding a relevant account of the user;

verifying if the relevant account of the user allows its users to see unrestricted contracts;

if not, preventing access to the unrestricted contracts;

thereby determining a set of contracts to which a user has entitlement.

Another aspect of the invention where the trading object is a business account provides a process for determining accounts user is entitled to use including:

finding all trading objects of the type of account;

finding a list of the parent organizations of a user beginning a search for the parent organizations with an immediate parent and proceeding to top level organization;

from the set of accounts finding all those accounts identifying at least one the users the parent organization as an account holder participant.

It may include the steps of retrieving a set of terms and conditions associated with a trading object for a current purchasing transaction, including:

selecting a trading mechanism;

retrieving the set of terms and conditions of the trading mechanism;

determining if the trading mechanism is associated with an account; and,

if the trading mechanism is associated with an account retrieving terms and conditions from the corresponding account trading object;

if the trading mechanism is not associated with an account, identifying any accounts to which the user belongs, if any accounts are identified selecting from the identified accounts an appropriate account for use for the current purchasing transaction, and retrieving terms and conditions of the selected account;

providing the retrieved terms and conditions to the user.

The method of the invention may further include using a trading object for the purpose of carrying out a business process for a user, including:

invoking a business logic task associated with a business process:

using the business logic task to retrieve a set of trading objects to which the user is entitled access;

for each trading object performing the following procedure:

retrieving a set of terms and conditions for the trading object:

for each term or condition causing the business logic task to transform properties stored in the terms and conditions into applicable parameters for each business policy task;

causing the business logic task to invoke each business policy associated with the respected term or condition passing the applicable parameters to the business policy.

Another aspect of the invention provides a method for generating provisions of a contract between a buyer and a seller on a data processing system including:

storing a compilation of selectable standardized trading components for generating terms and conditions of the contract;

the terms and conditions optionally referencing selectable business policies, and providing input parameters for invocation of the business policies;

the selectable business policies being adapted to use the parameters to execute business logic in accordance with appropriate terms and conditions of the contract;

wherein the selectable business policies include: pricing policies, predefined product set policies, shipping policies, payment policies, return policies, and refund policies;

the terms and conditions including the following types: Product set constraints, pricing, shipping, payment, limiting, approval, return/refund, and fulfillment components.

A pricing policy may contain a method to determine standard product pricing and an adjusted price based on an input parameter.

A predefined product set policy may contain a reference to a set of products.

A payment method policy may contain payment processing methods, including methods to authorize payment, check validity of authorization, capture payment, issue refund.

The payment method policy processes payments processes payments using a selected payment mechanism such as cheque, credit card, debit card, credit line, electronic funds transfer.

The shipping policies may include shipping mode and shipping charge policies, in which the shipping mode policy contains a reference to a shipping mode which specifies a shipping carrier and delivery priority, and the shipping charge policy contains a method to calculate a charge for shipping products to a specified location as defined by an input parameter.

Optionally the return policies include at least one return approval policy, at least one return charge policy; and at least one refund payment method policy, wherein the return approval policy contains a method to determine whether a return authorization is to be provided for a previously purchased product; and the return charge policy contains a method to determine a refund amount for a returned product; and the refund payment method policy contains a method to issue a refund for a returned product which may be based on product payment purchase method or based on a predetermined payment method irrespective of the product payment purchase method.

The pricing term type may include at least one pricing term of one the following subtypes:

a referenced price policy with a specified adjustment;

a referenced price policy with a specified adjustment on a selected product set;

a referenced price policy with a specified adjustment on a selected predefined product set policy;

a specified adjustment to all prices in a store customized price list in which element in the list references a product and sets the corresponding contract price for the product.

The product set constraints, if present, may include at least one product set constraint of one of the following subtypes:

include only products in a referenced product set policy;

include only products in a specified product set;

exclude all products in a referenced product set policy; and,

exclude all products in a specified product set.

The payment method term may include a payment subtype which references a payment method policy and optionally specifies a payment instrument.

The shipping term may include one or more shipping mode subtype, one shipping charge subtype, and optionally one or more shipping addresses; wherein the shipping mode subtype references a shipping mode policy; the shipping charge subtype references a shipping charge policy; and the shipping addresses contains the destination addresses of products purchased to be shipped.

The return/refund term optionally includes a return term, and optionally one or more refund payment method terms, wherein the return term contains a reference to a return approval policy, and a reference to a return charge policy, and the refund payment method term contains a reference to a refund payment method policy.

The approval term may include an optional order approval subtype containing a value which represents the value of an order, above which approval is required for orders. The limiting term optionally includes a right to buy subtype containing a value representing a maximum total value allowed for the sum total of all products purchased under the contract.

The fulfillment term optionally includes one or more fulfillment center subtypes containing a name of a fulfillment center which may be used to fulfill order for products placed under the contract.

Another aspect of the invention provides a method for generating provisions of a contract between a buyer and a seller on a data processing system including:

storing a compilation of selectable standardized trading components for generating terms and conditions of the contract;

the terms and conditions optionally referencing selectable business policies, and providing input parameters for invocation of the business policies;

the selectable business policies being adapted to use the parameters to execute business logic in accordance with appropriate terms and conditions of the contract;

wherein the selectable business policy consists of the following characteristics:

a name unique for the seller;

optional reference to a business object;

a set of predefined parameters;

a set of: method name, and reference to a corresponding task that implements the method for the policy.

Another aspect of the invention provides a method for generating provisions of a business account between an account holder and a seller on a data processing system including:

storing a compilation of selectable standardized trading components for generating terms and conditions of the business account;

the terms and conditions optionally referencing selectable business policies, and providing input parameters for invocation of the business policies;

the selectable business policies being adapted to use the parameters to execute business logic in accordance with appropriate terms and conditions of the contract;

wherein the selectable business policies include invoice formatting policies;

the terms and conditions including the following types:

buyer purchase order, default contract entitlement, credit line, and invoice presentation.

The invoice formatting policy may contain a method to produce an invoice document.

The purchase order type optionally includes one or more of the following subtypes:

a Blanket purchase order;

a Limited purchase order, and

may optionally include an individual purchase order subtype;

wherein the blanket purchase order contains a predefined allowable buyer purchase number which may be entered by a buyer when placing an order, wherein the limited purchase order contains a predefined allowable buyer purchase number and a value which represents a maximum total value of all orders which reference the limited purchase order number, and wherein the individual purchase order subtype contains indicator means indicating whether buyers can enter nonpredefined purchase order numbers when placing an order, and whether the nonpredefined purchase order numbers need to be unique for orders placed on behalf of an account.

The default contract entitlement may contain an indicator for indicating whether users of the account are entitled to use an unrestricted contract wherein the unrestricted contract is normally available for use by anyone.

The credit line may contain an indicator for indicating whether account users may use a credit line to purchase products.

The invoice presentation may contain reference to an invoice formatting policy.

Other aspects of the invention provide apparatus and software for implementing the aforethe varieties of the method of the invention as well as an article including a computer-readable signal-bearing medium for implementing the invention for use in a computerized trading system including means in the medium including program coding for the implementation of the invention, as described below and claimed in the claims.

The medium may be selected from the group consisting of electronic, magnetic, optical, biological, atomic data storage media, a modulated carrier signal, a modulated carrier signal including a transmission over the Internet

The invention provides apparatus as well as a computer program including computer program code means adapted to perform the steps of the aspects of the invention described above and claimed in the claims when the program is run on a computer.

### BRIEF DESCRIPTION OF THE DRAWINGS

FIG. 1 illustrates an example of pricing terms;

FIG. 2 illustrates an example of payment method terms;

FIG. 3 illustrates an example of obligation to buy terms;

FIG. 4 illustrates an example of order approval terms;

FIG. 5 illustrates an example of fulfillment center terms;

FIG. 6 illustrates an example of contract terms and conditions;

FIG. 7 illustrates a UML object relationship diagram of trading agreements in a store?;

FIG. 8 illustrates an example of a trading object relationship diagram;

FIG. 9 illustrates a flow chart depicting the determination of a user's entitlement to contracts;

FIG. 10 illustrates a flow chart depicting the process of finding a user's account;

FIG. 11 illustrates a flow chart depicting the retrieval of a set of terms and conditions associated with a trading object for a user;

FIG. 12. illustrates a flow chart depicting the process of obtaining the set of terms and conditions for a trading object;

FIG. 13 illustrates a flow chart depicting the use of a business object during a business process.

### DETAILED DESCRIPTION OF THE PREFERRED EMBODIMENTS OF THE INVENTION

The preferred embodiment of the invention is implemented in a software application which can be used on a computer system to construct trading devices, structures, or mechanisms as they may be termed such as contracts, RFQ's and accounts, and to carry out their use.

The following terminology will be used in the invention disclosure:

| Term | Definition |
|---|---|
| Business Policy | A set of rules followed by a business for a particular business process. |
| Business Policy Author | A user responsible for creation and maintenance of a business policy. |
| | It is important to note that different business policies are maintained by |
| | different roles, and there is no single role to maintain all business policies. |
| | Business Policy Author is an abstraction used in this document to designate |
| | any one of the roles responsible for editing one or more business policies. |
| Contract | An arrangement between a seller and one or more buyers, through which the |
| | buyers may purchase goods and services from the seller, based on the agreed |
| | upon terms and conditions, for the specified duration of time. |
| | Note: For the purpose of this feature, a contract does not refer to a one-time |
| | purchase order, but is the agreement for the terms of orders that the buyer |
| | may place during the validity period of the contract. |
| Contract Terms and Conditions | The set of rules agreed upon in a contract, which control the purchasing process |
| (Ts&Cs, or TC) | between the buyer and seller. |
| | For those areas of the business process regulated by business policies, the |
| | contract terms and conditions must reference one or more business policies. |
| Publishing a Business Policy | The process of activation of a policy. After a business policy is published, it |
| | may be referenced in contract terms and conditions. |
| Deployment of a contract | The process of activation of a contract in a store, so that buyers are able to |
| | purchase under the terms and conditions of the contract. |
| Requisition List | A requisition list is a set of items that may be used repeatedly to create an order. |
| | Once a requisition list is created, an order may be generated out of it without |
| | having to search the catalog for the required items. |
| Account | A buyer organization that has a relationship with a seller. An account may have |
| | a number of contracts concluded with the seller. |
| Account Holder | A participant in a contract. A contract may only have one account holder |
| | responsible for payment settlement. |
| Payment Settlement | the actual transfer of funds between buyer and seller |
| Payment Method | A means of payment collection from the point of view of the seller. Examples |
| | include credit card, debit card, p-card, cheque, and credit line. |
| Line of Credit | A payment method that provides the ability for a buyer to delay the payment |
| | settlement for orders. The account holder is responsible for payment settlement |
| | of outstanding balance on a credit line. |
| | If line of credit is used for payment method, then the seller will debit the |
| | account for an order at the time of payment capture. The account will be |
| | credited during payment settlement |
| Purchase Order | A method to relate one or more orders to a tracking number in the account |
| | holder's system. A Purchase Order number may be used for payment |
| | authorization. |
| | The following types of Purchase Orders are supported: |
| | 1. Blanket PO - may be used for unlimited number of orders |
| | 2. Limited PO - may be used for orders where the sum total amount of |
| | all orders, excluding taxes and shipping charges, does not exceed a specified |
| | amount. |
| | 3. Individual PO - corresponds to a single order. An individual PO |
| | may need to be checked for uniqueness among all orders placed for the account |
| | holder. |
| | Note that there is also another meaning of the term Purchase Order used |
| | in the industry, namely an order placed by a buyer and communicated to a |
| | seller; or by a reseller and communicated to the seller or manufacturer. In this |
| | document, purchase orders in this sense are not discussed, and hence this |
| | meaning is not attributed to the term Purchase Order. |
| Invoice | An itemized list of order Items and the prices paid by the buyer. An invoice |
| | corresponds to one or more Order Releases. An invoice also contains PO |
| | information. An invoice also contains the amount owed by the buyer to the |
| | seller. |

1.1 Business Policy

Business Policy is a concept applied/introduced with this invention. A business policy contains:

A reference to a business object

Examples of business objects in are Product Sets, Price Lists, Return/Refund Rules, etc.

A list of references to the tasks that implements the business policy for the corresponding interface.

For example, a pricing policy would have a reference to the task that calculates prices.

A payment method policy may have references to tasks for the following interfaces:

request payment authorization

check payment authorization

capture payment

produce a summary of captured payments

A set of properties, or name-value pairs, that are used as input to the policy task.

Since business policy contains a reference to the implementation method, the store designer may create new policies that implement logic differently. Thus, for example, a different pricing policy could fetch prices from a back-end price server, rather than computing them using and out-of-the-box software application mechanism.

Business policies serve the following purposes:

Facilitate the creation of contract terms and conditions by predefining some standard parameters.

Without business policies, an account rep would have to completely define all terms and conditions of a contract. This could be a lengthy process, depending on how elaborate the terms and conditions need to be.

The contract creation process could also be facilitated by copying from an existing contract. However, one has to make sure that the ‘template’ contract is always available. Furthermore, by copying a contract one would reproduce the entire set of terms and conditions, and would need to customize each one. A business policy provides the ability to naturally define ‘templates’ for individual terms and conditions, thereby making the process of contract creation less time consuming.

Limit the flexibility available to the account rep in creating contract terms and conditions.

In a selling enterprise, it is a frequently important to enforce control over the types of contractual arrangements the business enters in. The business policy mechanism provides a means of enforcing such control, and yet leave controlled flexibility in the hands of the account rep.

Hide the complexities of business object implementation from the account rep.

Frequently different contracts require different implementation from the selling organization. For example, some contracts may define product prices using the out-of-the-box software application pricing capabilities; other contracts may need to reference price lists that reside on an external price server. A business policy provides the implementation method that executes the policy (for example, ‘compute the price’). This method is hidden from the account rep who prepares contract terms and conditions; e.g. To define contract pricing terms, the account rep can simply refer to the defined price-lookup policy.

Allows stores to customize business policy for some customers.

Up to now, commands and tasks were defined for a store; different stores could customize the implementation of commands. With business policies, the same command could be implemented differently for different customers in the same store.

Facilitate the sharing of contracts among stores.

In some scenarios, a contract may need to be deployed in several affiliated stores. In this case, it is important to ensure that all the target stores respect the same set of terms and conditions. By defining policies at the store group level, a business may thereby enable the creation of contracts that reference those ‘store group’ policies; after that such contracts may be safely deployed in any store in the store group.

As described above, business policies may be defined for a store, or for a group of stores. In the latter case, a policy that is registered for a group of stores may be used by all stores in that group.

Business policies are meant to be used by the seller in running the store and in creating contracts. Typically, a business policy should be used in multiple contracts, although it is possible that a new business policy would be set up to satisfy the requirements of an individual large customer.

There is no single role responsible for managing all business policies; instead each area of the business is responsible for defining and updating its policies.

As described above, a business policy provides a template to the contract author; individual terms and conditions may adjust the policy in predefined ways.

1.1.1 Publishing a Business Policy

When a business policy is published in a store or in a store group, it is made available for use by contracts in the store or store group. Until it is published, a business policy cannot be referenced by Ts&Cs.

1.1.2 Business Policy Changes

A change in a business policy, may impact those contracts that reference the policy. For example, changes in a price list may affect deployed contracts.

Hence, it is important that the administrator who is changing a business policy first be prompted with the list of contracts which are affected by this change.

A business policy usually refers to a business object (such as a Trading Position Container). Effectively, a change in the business object changes the policies that reference it.

1.1.3 Summary of Business Policies

The following is a summary of the business policies enabled out-of-the-box.

| Policy | Description/Comments | number of policies in a store |
|---|---|---|
| Catalog Price Section | Itemized price list for a set of | 1 or more |
| | items in the master catalog | |
| Catalog Subsection | Set of products for inclusion | 1 or more |
| | in, or exclusion from, a | |
| | contract, or which may be | |
| | used in pricing adjustments | |
| Shipping Mode | Carrier and delivery type | 1 or more |
| Shipping Charge Type | E.g. Free shipping | 1 for each charge type |
| Payment Method | WPM Payment method, or | 1 or more |
| | Credit | |
| Return Charge | Amount of refund | 1 or more |
| Return Approval | Whether return will be | 1 or more |
| | automatically approved | |
| Refund Payment Method | Payment method used for | 1 or more |
| | refunds | |
| Invoice Format | Invoice Formatting Method | 1 or more |

The next several sections describe the supported business policies.

1.1.4 Catalog Price Section

This policy has one interface, which is invoked to compute the price of a product.

A B2B retail store will likely maintain a master catalog of available products with the corresponding standard prices. Furthermore, the catalog may be partitioned into multiple sections, where each section determines the standard prices for a logical grouping of products.

The prices in a section are published a business policy.

A catalog price section usually corresponds to a catalog group. The following is an example of a partitioning of a catalog by price section.

Normally a single item has price in only one catalog price section. However, the software application catalog allows items to be appear in multiple catalog groups, and hence the underlying model supports the ability for an item to have prices in multiple catalog price sections. The commands used by the catalog editor tool do not let this happen; instead the following rules are followed:

The master catalog is structured as a tree, i.e. each items belong in exactly one catalog group; no catalog group belongs to more than one parent catalog group.

For each catalog item, the commands automatically determine the price section where the corresponding offer should be placed.

If a catalog entry is removed, the corresponding offer is also removed automatically.

A price section contains a set of offers for items. Each offer has:

Price, possibly in several currencies

Optional expiry date

The quantity range to which the price applies

Effectively, a single product may have multiple ‘offers’ in a single price section, each offer corresponding to a different quantity. As a result, we enable volume based pricing.

A catalog price section may have an optional validity period. Note that individual offers may further restrict the validity period. An individual offer's expiry is determined as the intersection of the section validity period with the offer's validity period.

There is no tooling support provided for setting validity periods for either offers or price sections.

The category manager roles is responsible for designing the master catalog, i.e. Creating categories and assigning products to categories. The Merchant Buyer role is responsible for creating the products and setting the prices. The product manager role is responsible for dividing the master catalog into logical price sections.

In this release, the catalog price section policies are based on category level. Thus, for example, a site could be configured to have price sections created for categories at the second level of the product catalog tree. The following is an example:

In this example, the store configuration determines that price sections are created at level 2.

Note that products may not be created without prices, hence a product may not be created directly under top-level categories 1 and 2 in the example.

The catalog commands are responsible for creating price section policies when the catalog editor tool creates a category at the corresponding level. The catalog commands are also responsible for creating and updating offers in the appropriate price sections.

1.1.5 Catalog Subsection

This policy has one interface, used to retrieve the corresponding of products.

When creating terms and conditions of a contract, the account rep may need to adjust the standard prices for the customer. Furthermore, the price adjustments may not be the same for an entire catalog pricing section, but instead they may be different. For example, in the example above, category Ab may be specified at 10% off the standard price, while category Bc may be specified in the contract at 5% off the standard price.

A catalog subsection is the building block that allows account reps to partition a catalog price section, giving each subsection its own adjustment.

In some cases, account reps may prefer to not use the published catalog subsections, but to define their own partitions of the catalog price section for the purposes of the contract. However, for reuse in multiple contracts, catalog subsections may be published as store policies.

Normally a catalog subsection may not span multiple catalog price sections, i.e. All items in a catalog subsection are included in a single price section.

For maximum flexibility, as well as performance, a catalog subsection is represented as a flat list of items.

A Catalog subsection is typically put together out of catalog groups and individual items. It may in principle be specified as a collection of:

Catalog groups

Catalog groups with an additional set of catalog items

Catalog groups, but with an exclusions of a set of catalog items

Catalog subsection policies correspond to exactly one catalog group.

For every price section, a catalog subsection must be automatically created.

A subsection corresponds to exactly one category

Only selected categories have subsection policies created for them

A subsection may be included in another subsection

The catalog editor tool is responsible for designating those catalog groups for which subsection policies are created. Furthermore, the catalog editor tool must automatically update the subsection policies when products are added or deleted.

1.1.6 Shipping

The shipping policies include:

1. Shipping Mode. This controls:

Supported carriers

Delivery type that must be requested from the carrier. Examples are:

By Air

By Ship

Overnight

3 Days

1 Week

Registered mail

Insured

The shipping mode policy does not have any interfaces defined for it.

2. Shipping Charge Type

This policy has one interface, used to compute shipping charges.

The following types of shipping charges are supported:

i) shipping charges calculated by the seller when the order is captured.

ii) no shipping charge.

iii) shipping charges invoiced by and paid to the carrier upon receipt of goods by the buyer.

Store services component is responsible for maintaining the shipping mode policies.

Shipping charge type policies are bootstrapped, i.e. Are created for every store.

1.1.7 Payment Method

The payment method policy has the following interfaces:

Authorize Payment

Check Payment Authorization

Capture Payment

Issue Refund

Produce a summary of captured payments

Example of payment method policies are:

Credit Card, e.g. Visa, MasterCard, Amex, Diners

SET Wallet for a credit card

Debit Card

Procurement Card

ACH

APACS

Cheque

Credit Line maintained by seller

As is the case with other policies, if a particular policy (e.g. Payment method) is not published in a store, then that payment method may not be used by contracts

1.1.8 Return Approval

A Returns approval policy specifies when a return will be automatically approved.

It contains the following parameters:

number of days following shipdate during which return will be automatically approved

1.1.9 Return Charge

A return charge policy specifies the amount by which the original purchase price is reduced before refund is issued for an RMA. It contains the following parameters:

Restocking fee per RMA

Restocking fee per item

Currency of restocking fees

Percentage of purchase price refunded

1.1.10 Refund Payment Method

This refund payment method policy specifies the payment method used to transfer funds to the buyer for goods returned.

The possibilities are:

Same payment method as used to place order

Issue credit to account's Credit Line

This policy contains one interface, used to issue a refund. For the case where the same payment method as original order is specified, this interface invokes refund interface of the original payment method policy.

1.1.11 Invoice Formatting

This policy defines the method used to format an invoice, i.e. it corresponds to a basic look and feel of an invoice.

This policy has one interface, used to produce an invoice.

1.2 Contract Support

If a seller and a buyer agree to a contract, then the buyer is enabled to purchase certain items with the specified terms and conditions. Each of a contract's Terms&Conditions may reference one or more policies that apply to a store.

The contract negotiations process, whether it's offline, RFQ, Auction, or a two-party online negotiation, is out of scope of this feature. Once the contract is negotiated, this feature provides functionality to record and deploy the contract.

The buyer and seller are participants of the contract. Note that in some cases there could be more than one buyer organization for a contract. This is the case, for example, in the distributor-reseller model, where the contract is between the reseller and the distributor, while the reseller's customers have buyer access to the contract.

1.2.1 Contract Approval

A contract may need to be approved before it is deployed. The Account Manager role is responsible for approving or rejecting contract.

A Store configuration parameter determines whether contracts in the store require approval.

Contract approval automatically triggers contract deployment.

Once a contract has been submitted for approval, it may no longer be changed. If modifications are required, a new version must be created.

1.2.2 Contract Deployment

A contract may be deployed in one or more stores; all stores to which a contract has been deployed must be in the same store group. This is so to ensure that the policies quoted by the terms and conditions of a contract are understood by the store to which the policy is deployed.

Approval may be required for the deployment of a contract. This is determined by store configuration, a single setting applies to all contracts in a store.

1.2.3 Contract Entitlement

Buyer participants are entitled to view products and prices covered by the contract, and to place orders.

Some buyer participants may only be entitled to specific Ts&Cs within a contract. Thus, for example, a purchasing department in an organization may have access to the Ts&Cs that specify prices for furniture, while other departments only have access to buy office supplies under the contract.

1.2.4 Store Default Contract

A contract that grants entitlement to all buyers in the store to purchase is an unrestricted contract.

A store may have a ‘default contract’, which is an unrestricted contract that specifies the default set of terms and conditions. Users who are not registered, or who do not have their own contracts with the seller may purchase under the default contract in the store.

A default contract implements the fixed price trading mechanism.

A store default contract is created and deployed when a store is created. No tooling support is provided to administer the default contract directly, e.g. To modify the contract terms and conditions, or to change entitlement. However, the CSA, admin console, and store services tools are able to modify the business objects that the contract Ts&Cs reference.

For example, the master catalog editor is able to add or modify products and prices. These updated prices are automatically made available through the default contract.

1.2.4 Contract Versioning

After a contract has been submitted for approval, it may no longer be changed. However, a new version of the contract may be created, which is primed with the all the same properties (such as name, profile, Ts&Cs) as the original contract.

Different versions of a contract share the same name, but have different version numbers.

1.2.5 Contract Components

A contract consists of:

Name, and description

Validity period

Unstructured documentation

Optional account responsible for orders placed under the contract

If an account is specified, then invoicing, purchase order verification, and Credit Line payment method, are controlled by the account Ts&Cs.

Participants, such as:

Seller

Buyer

Terms and Conditions

The following is a summary of Terms and Conditions available out-of-the-box.

| | Number | |
|---|---|---|
| Contract Terms | of TCs in | |
| and Conditions | a contract | Description/Comments |
| Catalog Price Section | 0 or more | Price TCs |
| with Adjustment | | Only one customized price list may be created |
| | | in a contract with the contract editor tool. |
| Catalog Price Section | 0 or more | |
| with Selective | | |
| Adjustments | | |
| Customized Price List | 0 or more | |
| Entire Master Catalog | 0 or 1 | |
| with optional | | |
| adjustment | | |
| Catalog Subsection | 0 or more | Constraints on the set of products covered by a |
| Inclusion | | contract |
| Customized Product | 0 or more | |
| Set Inclusion | | |
| Catalog Subsection | 0 or more | |
| Exclusion | | |
| Customized Product | 0 or more | |
| Set Exclusion | | |
| Shipping Mode | 0 or more | Shipping Tcs. If none specified, then all |
| | | shipping modes supported by the store may be |
| | | used for order items under the contract |
| Shipping Charge Type | 1 | |
| Ship-to Address | 0 or more | |
| Payment Method | 1 or more | Described in the Billing, Invoicing, and credit |
| | | management feature spec. |
| Right To Buy Amount | 0.or.1 | Spending limit |
| Right To Buy Quantity | 0 or more | |
| Obligation To Buy | 0 . . . 1 | |
| Amount | | |
| Obligation To Buy | 0 or more | |
| Quantity | | |
| Order Approval | 0 or . . . 1 | Approval not required if not specified |
| Return | 0 or . . . 1 | No return TC means returns not allowed |
| Refund Payment | 0 or more | May not be specified if returns not allowed |
| Method | | |
| Fulfillment Center | 0 or more | If not specified, then any fulfillment center of |
| | | the store may be used; otherwise only the ones |
| | | in the contract. |

The next several sections describe the terms and conditions of a contract.

1.2.6 Price

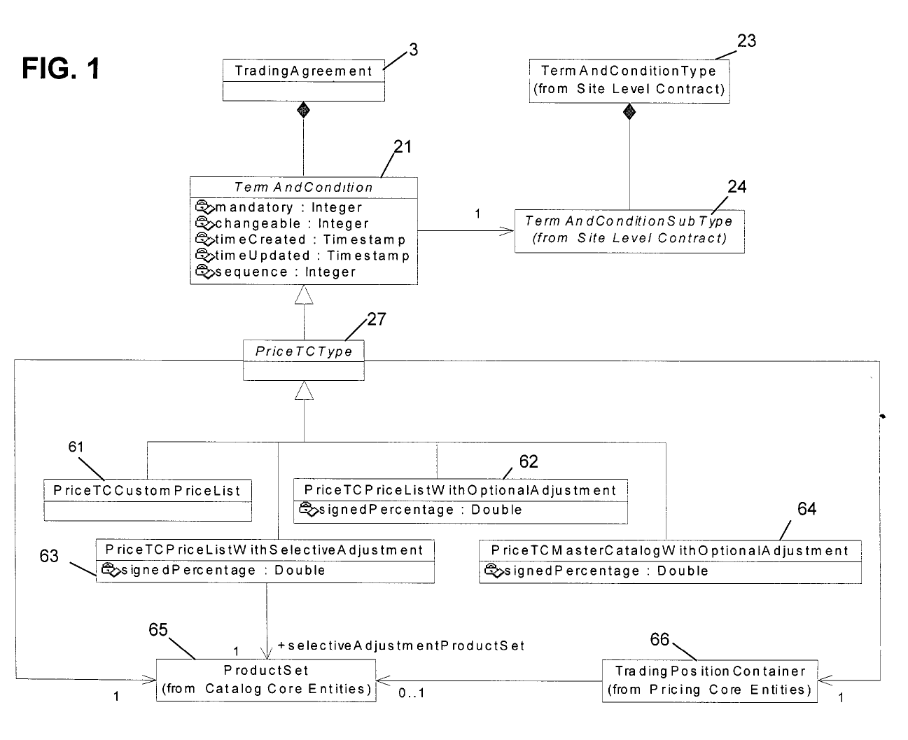

FIG. 1, which illustrates an example of pricing terms, depicts relationships of pricing terms and conditions as implemented in an embodiment of the invention. Trading Agreement 3 includes terms and conditions 21 which reference subtype 24. Subtype 24 is a member of term and condition type 23. PriceTCType 27 is a type of term and conditions 21. PriceTC Custom PriceList 61, Price TCPriceListWith Optional Adjustment 62, Price TC Price List With Selective Adjustment 63, and price TC Master Catalog With Optional Adjustment 64 are types of terms and condition 21. Price TC Price List with Selective Adjustment 63 references Product Set 65, which is also referenced by Price TC Type 27 and may be referenced by Trading Position Container 66, which itself is referenced by Price TC Type 27.

This specifies the prices for items available under the contract.

A contract may include several pricing terms and conditions. The following types of pricing terms and conditions may be used:

Catalog Price Section with price adjustment

This price TC in a contract states that the prices are based on the referenced catalog price section, but are adjusted up or down (mark-up vs discount) by the indicated percentage.

Catalog Price Section with selective price adjustment

This price TC in a contract states that the prices are based on the referenced catalog price section, but the prices of items in the referenced catalog subsection are adjusted up or down by the amount specified in the TC.

Note that the adjustment may be applied only to a product set defined in a catalog subsection policy.

Customized Price List

This price term in a contract states that the prices are described in the referenced price list. Note that the referenced price list is not a policy, but is customized for this contract.

This type of pricing terms and conditions will not be tooled through the Contract Editor. The purpose for enabling it is to allow integration with external systems, which may define contract price lists separately from the software application catalog prices.

Entire Master Catalog with Optional Price Adjustment

This price term in a contract states that all standard prices in the store apply to the contract, possibly with an adjustment. For instance, the contract may give 10% off all prices in the store.

Standard prices are managed by either the catalog editor tool, or may be mass loaded.

Those terms and conditions that reference a Catalog Price Section policy, have a deployment option, called ‘Deploy by Copy’. If this option is set, then when the contract is deployed the prices will be copied into an itemized price list, to be used by this contract exclusively. This way, even if the reference catalog price section policy changes, the contract prices will not be affected. Furthermore, with the ‘deploy by copy’ option the catalog subsection policies used for selective adjustments are also copied into product sets that are used by this contract exclusively.

The downside of using this option is that it leads to the creation, and the need to maintain, large amounts of data in the price lists.

Given that a number of pricing terms and conditions may be specified in a contract, it is possible that a single product may have several prices in the context of a single contract. For this release, the default behaviour to is choose the lowest price available under the contract. This behaviour may be overridden.

It is important to note that price terms of a contract implicitly restrict the product set available to a contract. A product must have a price for it to be able to be sold under the terms of a contract.

At least one price TC must be specified in a contract.

If no product set constraint terms are specified for the contract, then all products with a price under the price terms are available for sale under the contract.

Product set constraint terms of a contract, if present, further restrict the available set of products, specifying the inclusion criteria for products under a contract. This is described below in more detail.

1.2.7 Product Set Constraints

The following are the types of product set constraint terms and conditions that may be defined in a contract:

Inclusion of a Catalog Subsection Policy

This TC states that the products in the catalog subsection are covered by the contract

Inclusion of a custom product set

This TC states that the products in the custom product set are covered by the contract

Exclusion of a Catalog Subsection Policy

This TC states that the products in the catalog subsection are not covered by the contract

Exclusion of a custom product set

This TC states that the products in the custom product set are not covered by the contract

A customized product set may be specified using the following:

A set of catalog subsections, which are published as store policies.

A set of catalog items may be excluded from each subsection

An explicit list of catalog items

In the situation where a product is in both an Inclusion TC and in an Exclusion TC, the Exclusion TC takes precedence, i.e. In this case the product would not be included in the contract.

Those terms and conditions that reference a Catalog Subsection policy, have a deployment option, called ‘Deploy by Copy’. If this option is set, then when the contract is deployed the catalog subsection will be copied into a product set, to be used by this contract exclusively. This way, even if the referenced catalog subsection changes, the contracted product set will not be affected. The downside of using this option is that it leads to the creation, and the need to maintain, large amounts of data in the product sets.

1.2.8 Interaction between Price and Product Set Constraint Terms and Conditions

If no product set constraints terms and conditions are specified in a contract, then all items for which a price is specified in the pricing terms and conditions, are available for sale through the contract.

If product set constraint terms and conditions are specified, then only those products included in the product set, and for which the price terms specify a price, may be purchased under the contract.

The following rules are followed to determine which items are available for sale under a contract:

1. If there are 1 or more product exclusion TCs, then those products may not be ordered. This rule has the highest priority, in that it overrides all other rules.

2. If there is at least one product set inclusion TC, then can order any item in the product set inclusion TCs, provided there is a contracted price for it, and it is not excluded by rule 1.

3. If there are no product set inclusion TCs, then can order any item for which there is a contracted price, and which is not excluded by rule 1.

4. A contracted price for an item exists if:

i) there is a pricing TC in the contract that covers this item

ii) if there are no pricing TCs defined in the contract at all, then an offer exists for the item in one of ‘standard price lists’ available in the store.

5. A pricing TC covers an item if the TC references a price list (either itemized price list, or a Catalog Price Section policy) that has an offer for the item.

1.2.8.1.1 Shipping

The following shipping terms and conditions may be specified:

Shipping mode

This TC references a shipmode policy, and specifies a shipping mode that may be used for order items created under the contract.

If no shipping mode terms and conditions are specified in a contract, then any shipping modes published in a store may be used for orders placed under the contract.

Shipping Charge Type

This TC reference a shipping charge type policy. Exactly on TC of this type must be specified in each contract.

Ship-to Address

This TC specifies a ship-to address. The set of ship-to address TCs in a contract forms a allowed list of ship-to addresses for order items placed under the contract.

If at least one ship-to address is specified, then items purchased under the contract may only be shipped to one of the specified addresses.

If no ship-to addresses are specified in a contract, buyer must provide the ship-to address at order capture time.

1.2.8.1 Payment

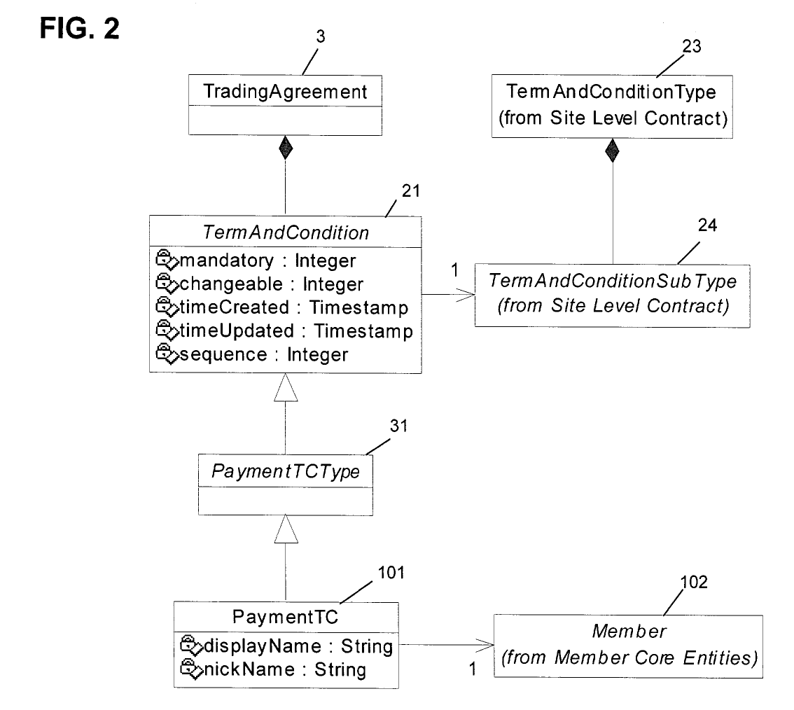

FIG. 2, which illustrates an example of payment method term relationships, depicts Payment TC Type 31 which is a type of Term and Condition 21. Payment TC 101, a type of Payment TC Type 31, references Member 102.

The following is a summary of the terms and conditions that may be specified:

Payment method

This is selected from the predefined policies of the store. Associated with it is payment information specific to the contract, if required by the payment method.

If no payment method terms and conditions are specified in a contract, then any payment vehicles supported by the store may be used to pay for goods purchased under the contract.

1.2.8.2 Right To Buy Amount

This TC specifies a limit on the combined value of all orders to be placed under a contract. If this term is specified, then a check will be made when authorizing payment for the order, to make sure that the contract's right-to-buy limit is not exceeded. If the limit is exceeded, then order processing will fail.

At most one right-to-buy-amount TC may be specified in a contract.

If this TC is not specified, then there is no limit to the value of orders that can be placed under the contract.

1.2.8.3 Right To Buy Quantity

This TC specifies a limit on the quantity of a particular item that may be purchased under a contract. If this TC is specified, then a check will be made before processing an order, to make sure that the contract's right-to-buy limit is not exceeded. If the limit is exceeded, then order processing will fail.

The TC includes:

Item ID

Required quantity and unit of measure

Period of time in days

At most one right-to-buy-quantity TC may be specified in a contract.

If this TC is not specified, then there is no limit to the quantity of goods that can be purchased under the contract.

No runtime enforcement of this TC is provided in this release.

1.2.8.4 Obligation To Buy Amount

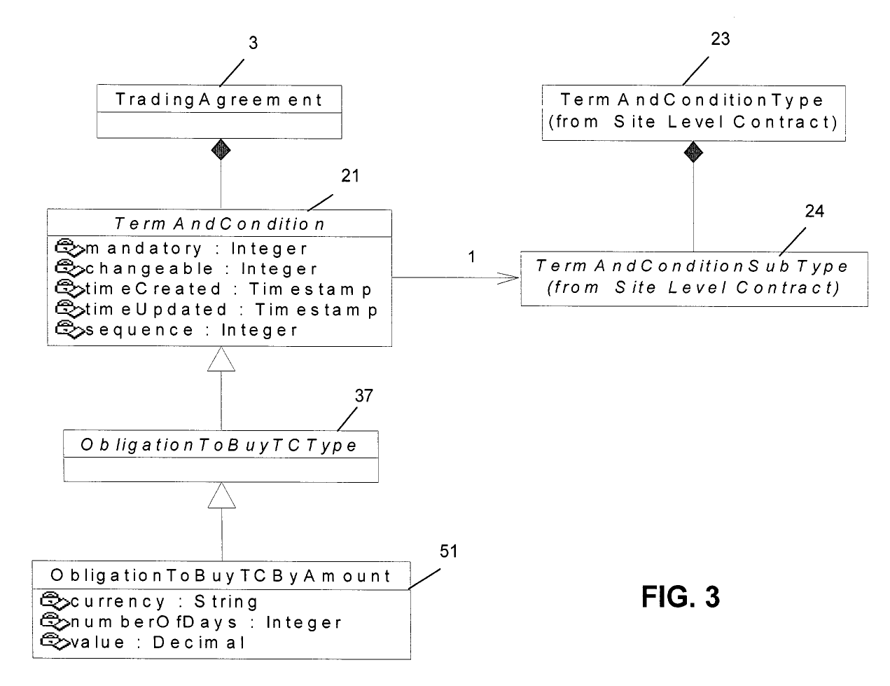

FIG. 3, which illustrates an example of obligation to buy term relationships, depicts an Obligation to Buy TC Type 37, of which Obligation to Buy TC by Amount 51.

This TC specifies the minimum value of all orders that must be placed under the contract within a specified time after the contract is deployed.

The TC includes:

Required Amount

Period of time in days

If after the specified period of time the total value of all orders is less than the required amount (i.e. The buyer has not complied with the contract), then the seller may cancel the contract at that point.

In this release there is no out-of-the-box support for automatic cancellation of contract in case of buyer noncompliance. Instead, the count rep is responsible to review the contract usage history using operational reports, and to take recourse action manually if necessary.

20 1.2.8.5 Obligation to Buy Quantity

This TC specifies the minimum quantity of an item that must be purchased under the contract within a specified time after the contract is deployed.

The TC includes:

Item ID

Required quantity and unit of measurePeriod of time in days

If after the specified period of time the total value of all orders is less than the required amount (i.e. The buyer has not complied with the contract), then the seller may cancel the contract at that point.

In this release there is no out-of-the-box support for automatic cancellation of contract in case of buyer noncompliance. Instead, the count rep is responsible to review the contract usage history using operational reports, and to take recourse action manually if necessary.

1.2.8.6 Return/Refund

The following return and refund terms and conditions may be specified:

Return

This TC specifies the return policies used under the contract.

The following must be specified:

Return Approval Policy

Return Charge Policy

Refund payment method

This TC specifies the refund method policy that applies under the contract.

For an individual refund, the buyer may request any refund payment method specified as a TC in the contract.

1.2.8.7 Order Approval

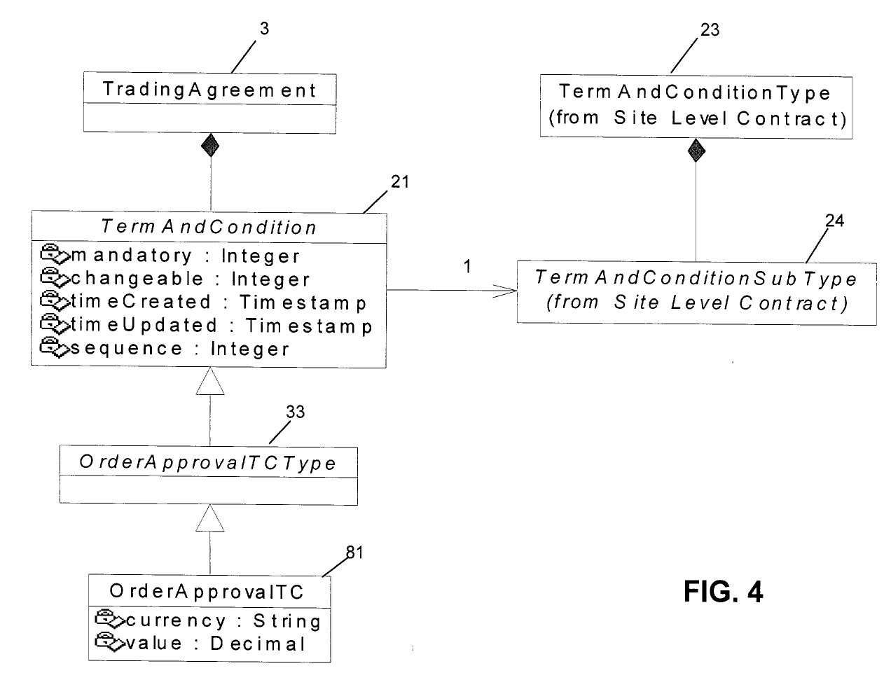

FIG. 4, which illustrates an example of order approval term relationships, depicts an Order Approval TC Type 33, of which Order Approval TC 81 is a type.

This TC specifies the requirement for orders placed under the contract. This could be one of:

No Approval

Single Level Approval. In this case, an optional approver email address needs to be specified. Whenever an order is submitted for approval, an email can be sent to the approver.

Also, the TC contains the minimum order amount that requires approval

For orders below the specified amount to not require approval, even if the SingleLevelApproval requirement is set, no approval is required.

If approval is required, then the Buyer Approver role within the buyer organization is responsible for approving or rejecting orders under this contract.

Exactly one order approval TC must be specified in a contract.

1.2.8.8 Fulfillment Centre

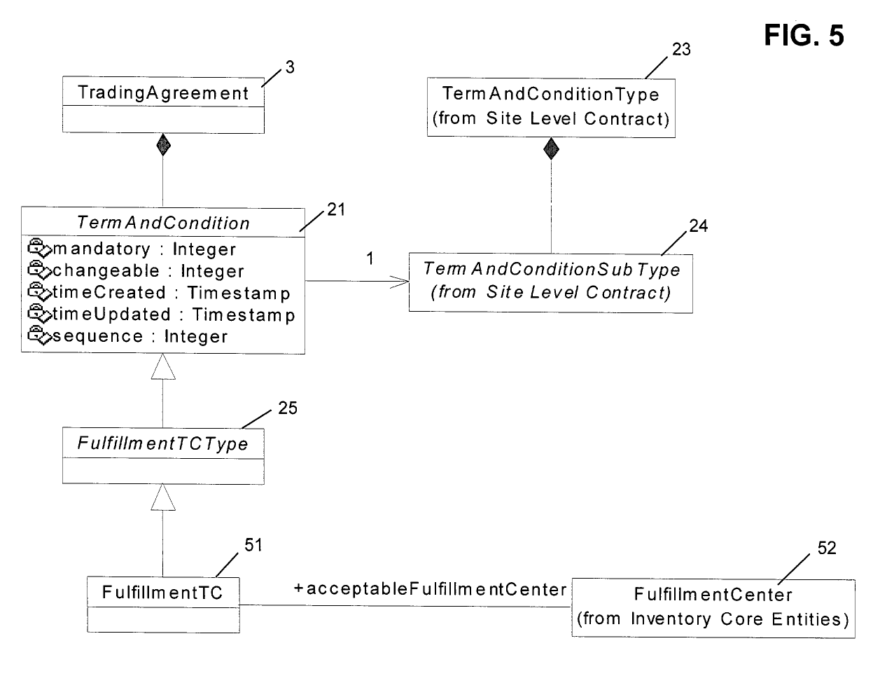

FIG. 5, which illustrates an example of fulfillment center term relationships, depicts Fulfillment TC Type 25, of which Fulfillment TC 51 is a type. Fulfillment TC 51 references Fulfillment Center 52 providing a fulfillment center relationship.

This Term specifies the fulfillment centre from which order items placed under the contract must be fulfilled.

At most one fulfillment centre TC may be specified in a contract.

If the fulfillment centre TC is not specified, then the fulfillment centre is determined automatically based on inventory availability and store picking policy.

Account Ts&Cs

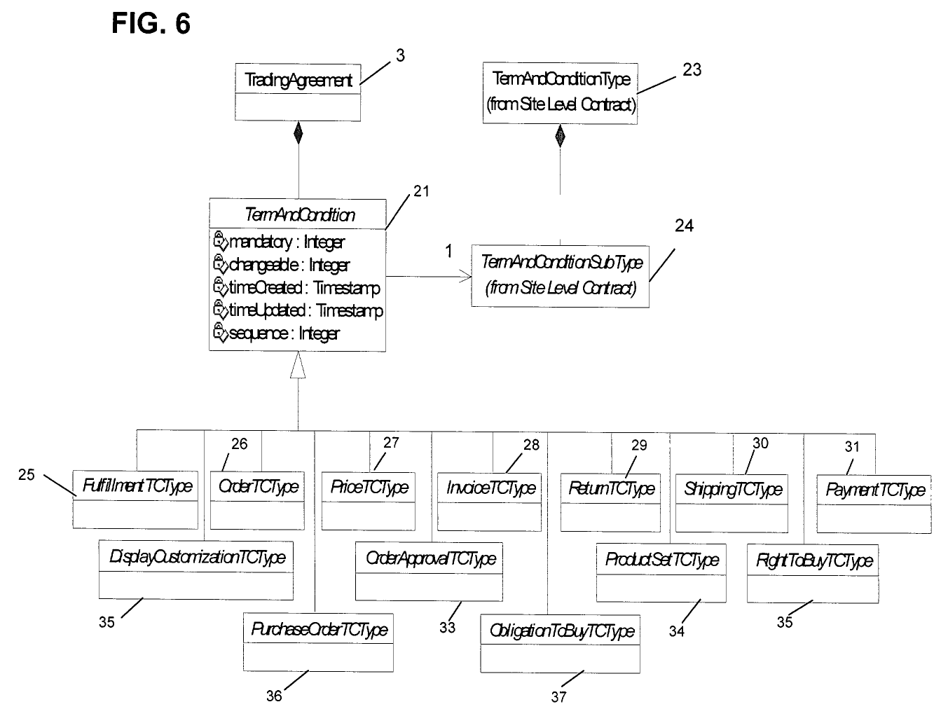

FIG. 6, which illustrates an example of contract terms and condition relationships, depicts a number of corresponding term types, 25 to 37, such as Fulfillment TC Type 25, Invoice TC Type 28, and Right To Buy TC Type 35 among others as can be readily seen in the figure.

Blanket Purchase Order Number

Several blanket PO numbers may be defined for an account

Limited Purchase Order Number

Specifies the spending limit of the PO.

Several Limited PO Numbers may be defined for an account.

Whether Individual Purchase Order is allowed

This includes the following options:

Individual PO allowed when entering an order.

For Individual PO, during payment authorization a check is made that the PO number must be unique across all orders placed for the account.

Invoice sent by email, or printed and included in box, or both

Invoice Look and Feel

This sets the look and feel of an invoice

Default Contract Entitlement

This TC determines whether a user is allowed to see the items covered by the default contract (aka fixed price trading mechanism), and place orders under that contract.

Business Policy/Contract Interaction

The terms and conditions of a contract may reference zero or more business policies.

The following table lists contract terms and conditions and the policies that they may reference

| | Catalog | Catalog | Custom | Custom | | Shipping | | | Return | | Returns |
|---|---|---|---|---|---|---|---|---|---|---|---|
| | Price | Sub- | Price | Product | Shipping | Charge | Payment | Invoice | Authori- | Return | Payment |
| | Section | section | List | Set | Mode | Type | Method | Format | zation | Charge | Method |
| Catalog | X | | | | | | | | | | |
| Price | | | | | | | | | | | |
| Section with | | | | | | | | | | | |
| Adjustment | | | | | | | | | | | |
| Catalog | X | X | | | | | | | | | |
| Price | | | | | | | | | | | |
| Section with | | | | | | | | | | | |
| Selective | | | | | | | | | | | |
| Adjustments | | | | | | | | | | | |
| Customized | | | X | | | | | | | | |
| Price List | | | | | | | | | | | |
| Entire | | | | | | | | | | | |
| catalog with | | | | | | | | | | | |
| optional | | | | | | | | | | | |
| Adjustment | | | | | | | | | | | |
| Catalog | | X | | | | | | | | | |
| Subsection | | | | | | | | | | | |
| Inclusion | | | | | | | | | | | |
| Customized | | | | X | | | | | | | |
| Product Set | | | | | | | | | | | |
| Inclusion | | | | | | | | | | | |
| Catalog | | X | | | | | | | | | |
| Subsection | | | | | | | | | | | |
| Exclusion | | | | | | | | | | | |
| Customized | | | | X | | | | | | | |
| Price List | | | | | | | | | | | |
| Exclusion | | | | | | | | | | | |
| Shipping | | | | | | | | | | | |
| Mode | | | | | | | | | | | |
| Shipping | | | | | | X | | | | | |
| Charge | | | | | | | | | | | |
| Type | | | | | | | | | | | |
| Ship-to | | | | | | | | | | | |
| Address | | | | | | | | | | | |
| Payment | | | | | | | X | | | | |
| Method | | | | | | | | | | | |
| Right To | | | | | | | | | | | |
| Buy | | | | | | | | | | | |
| Amount | | | | | | | | | | | |
| Right To | | | | | | | | | | | |
| Buy | | | | | | | | | | | |
| Quantity | | | | | | | | | | | |
| Obligation | | | | | | | | | | | |
| to Buy | | | | | | | | | | | |
| Amount | | | | | | | | | | | |
| Obligation | | | | | | | | | | | |
| to Buy | | | | | | | | | | | |
| Quantity | | | | | | | | | | | |
| Order | | | | | | | | | | | |
| Approval | | | | | | | | | | | |
| Return | | | | | | | | | X | X | |
| Refund | | | | | | | | | | | X |
| Payment | | | | | | | | | | | |
| Method | | | | | | | | | | | |
| Fulfillment | | | | | | | | | | | |
| Center | | | | | | | | | | | |

1.2.9 Contract Based Purchasing

There are the following ways of purchasing in a contract environment:

1. Buyer selects the contract after logon. Only items covered by the contract are displayed. The prices shown correspond to the contracts.

2. Buyer browses the catalog without selecting any contracts. The system automatically displays all items he can buy under all contracts the buyer is entitled to. If an item is available under multiple contracts, prices are displayed, along with the contract, for each item.

SUMMARY

Business Policy

A business policy consists of:

Name (unique within the store)

Reference to a business object

A set of properties, or name-value pairs

A set of:

interface name

reference to the corresponding task that implements the interface

Invoking Business Policies

1. At runtime, when trading is being performed, the business logic retrieves the trading object.

2. The business logic retrieves the set of Terms and Conditions associated with the current task.

3. The business logic transforms the data specified in the terms and conditions into parameters for the corresponding business policies.

4. The business logic invokes the business policies specified in the terms and conditions.

5. The business policy invocation logic augments the parameters with the properties specified in the business policy

6. The business policy interface is invoked.

Trading

A trading object consists of:

unique name

a set of Participants

a set of Terms and Conditions

a set of Attachments

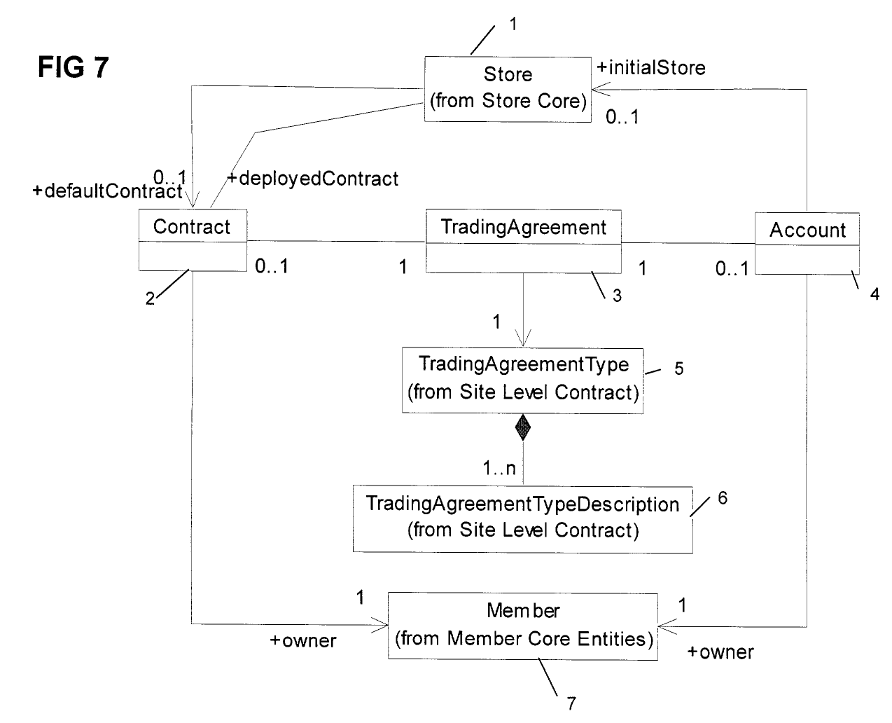

FIG. 7 illustrates an UML object relationship diagram of trading agreements in a store. As may be observed, store 1 may have an Account 4 and may have a default contract 2. Store 1 may have any number of private contracts. Contract 2, and Account 4 are associated with Trading Agreement 3, which has a Trading Agreement Type 5 which includes a number of descriptions Trading Agreement Type Description 6. Contract 2 and Account 4 have an owner Member 7.

Participant

A participant consists of:

Role

The following roles may be used by the different trading objects:

Contract trading object:

Buyer

Buyer Approver

Seller

Seller Approver

Account trading object:

Account Holder

Buyer

reference to user or organization fulfilling the role

reference to the Trading object

optional reference to the TC

if the participant is qualified by a TC, it means that the TC is restricted for use by the participant.

Terms and Conditions

A TC consists of:

Reference to Trading object

A set of properties (these qualify the behaviour of the TC)

reference to one or more business policies

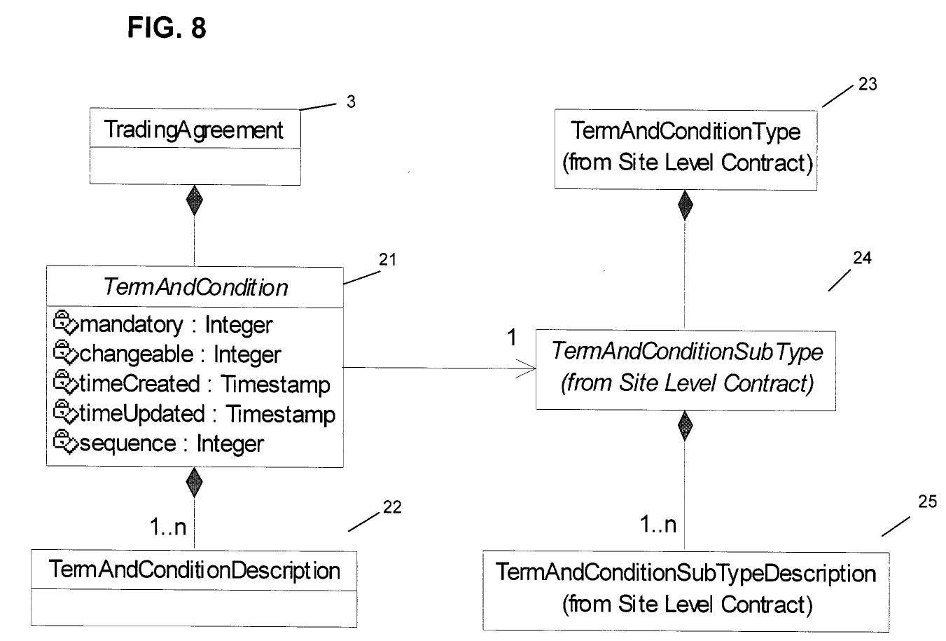

FIG. 8, which illustrates an example of a trading object relationship diagram, illustrates trading agreement 3, which has a number of terms and conditions 21, which have a number of descriptions 22. Each term and condition 21 specifies a subtype 24. Each subtype 24 contains subtype descriptions 25. Term and condition subtypes 24 are contained by term and conditions 23 determined from a site level contract.

Attachment

An attachment consists of:

URI

Mime type

optional content

Establishment of Trading Objects a User is Allowed to Use

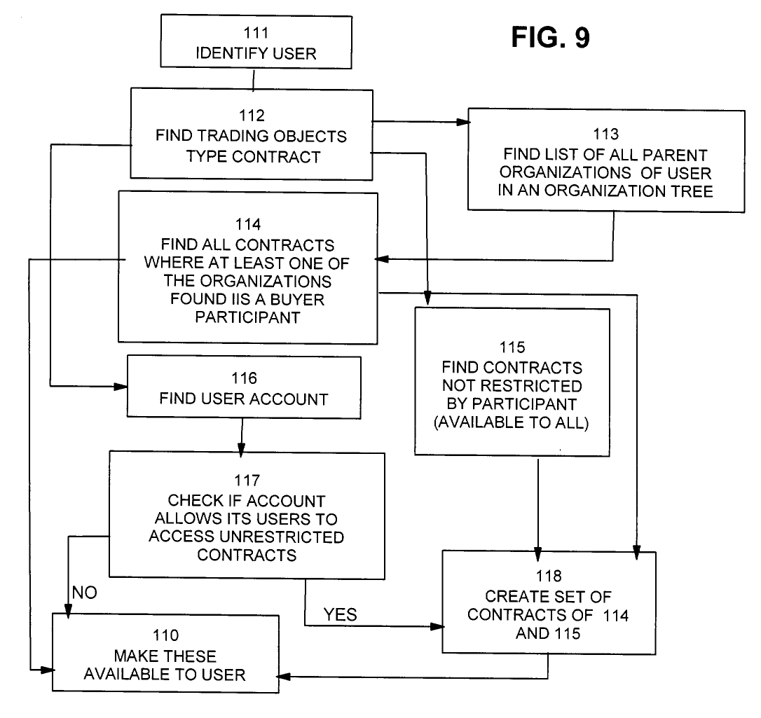

FIG. 9 presents a flow chart depicting the determination of a user's entitlement to use contracts in order to make a purchase. The software of the invention running on a computer system that has access to contracts used for purchasing, identifies the prospective user, 111, and finds trading objects of type contract, 112. It also finds a list of all parent organizations of the user in an organization tree, 113. Using the information from step 112 it finds contracts not restricted by participant (ie. Ones that are available to all), 115, and finds all contracts where at least one of the organizations is a buyer participant, 114. It also finds an appropriate account for the user, 116, and checks if the account allows its users to access unrestricted contracts, 117. It then creates, 118, a set of contracts from steps 114, 115, and 117, and makes these available to the user, 110.

The Participant component of a trading object is used to determine entitlement.

For example, the following process may be used to determine the set of contracts a user has access to:

1. Find all trading objects of type ‘contract’

2. Find the list of the user's parent organizations, beginning with the immediate parent, to the top-level organization

3. Within the set from (1), find all those contracts where at least one of the user's parent organizations located in (2) is a Buyer Participant.

4. Within the set from (1), find all those contracts which are not restricted to buyer participants, but may be used by anyone in the store

5. Find the user's account (see below for algorithm to do that).

6. Check if the user's account allows its users to see the fixed-price contracts. If not, then remove the contracts obtained in step (4) from the list.

7. The set obtained from step (3), plus, depending on account setting, the set from step (4) together constitute the set of is the set of contracts that a user is entitled to.

Note that the some of the above steps may be performed with a single SQL query given a well designed relational database table layout. For example, our implementation combines the SQL for steps (1) through (3) and (6).

Similarly we may find the accounts a user is entitled to:

1. Find all trading objects of type ‘account’

2. Find the list of the user's parent organizations, beginning with the immediate parent, to the top-level organization

3. Within the set from (1), find all those accounts where at least one of the user's parent organizations located in (2) is a Buyer Participant.

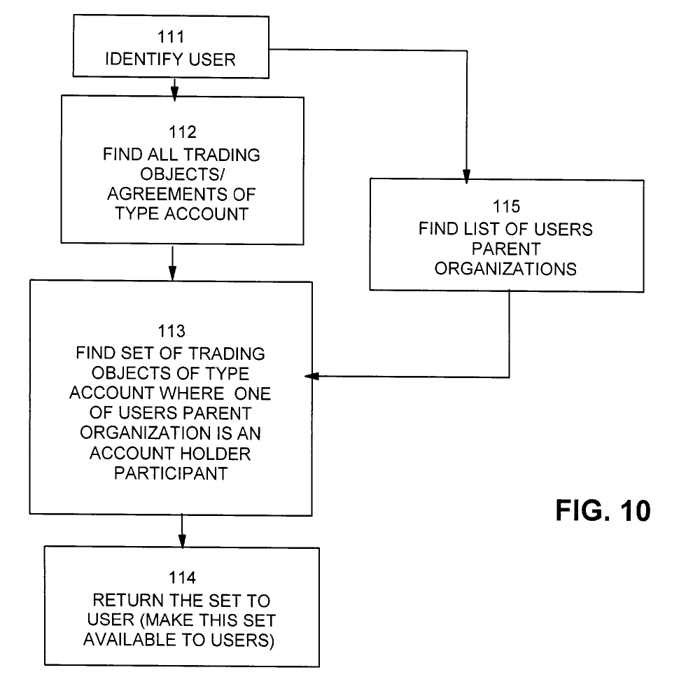

As with contracts, the above steps may be performed with a single SQL query given a well designed relational database table layout. FIG. 10 presents a flow chart depicting the process of finding a user's account using the software of the invention. The user is identified, 111, all trading objects of type account are found, 112, as well as a list of the user's parent organizations to the top level of the organizations, 115. From the results of steps 112, and 115, the software finds the set of trading objects of type account where one of the user's parent organizations is an account holder participant, 113. This set is returned to the user, 114, ie, made available for use by the user.

During purchasing flow, each order item must be associated with a trading mechanism. Either the user selects the appropriate trading mechanism when placing the order, or the trading mechanism is assigned by the system; for example the ‘default contract’(aka fixed price trading mechanism) is assigned automatically if the user does not select a contract. Each RFQ has its own trading mechanism. Each contract is a trading mechanism, and the user selects the contract for each item when placing the order.

Retrieving a Set of Terms and Conditions Associated with a Trading Object

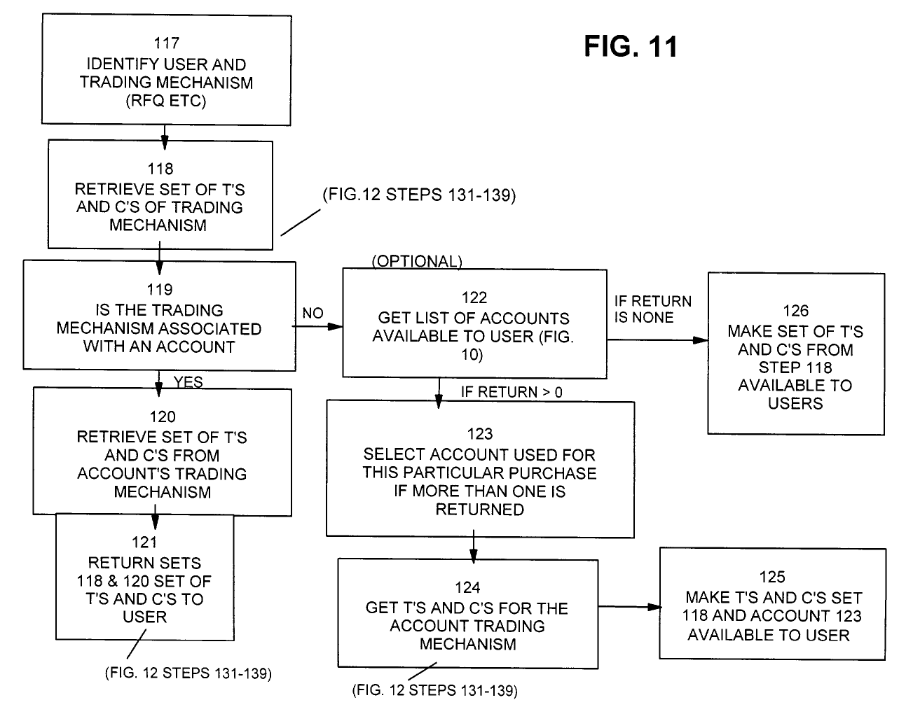

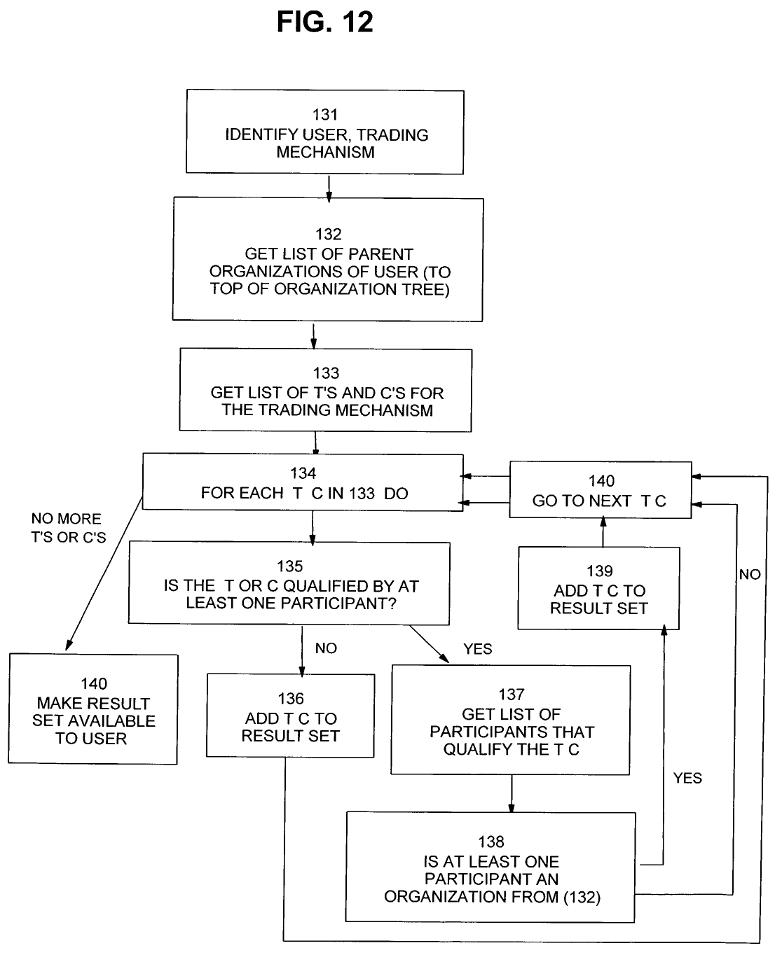

FIG. 11, presents a flow chart, depicting the retrieval of the total set of terms and conditions associated with a trading object for a user that may reference an account. The software of the invention identifies the user and the type of trading mechanism used, 117, and retrieves a set of terms and conditions of the trading mechanism, 118. It determines whether the trading mechanism is associated with an account, 119, and if so retrieves the set of terms and conditions from the account's trading mechanism, 120, and returns sets obtained in steps 118, and 120 to the user ( see FIG. 12, steps 131 to 139). If the trading mechanism is not associated with an account, it obtains the list of accounts available to a user ( see FIG. 10), 122, and if none are returned it forms the set of terms and conditions from step 118 available to the user; however, if a list of accounts is available to the user, it selects the appropriate account to be used for the particular purchase if more than one is returned, 123; gets the terms and conditions for the account trading mechanism (FIG. 12, steps 131 to 139) and makes the terms and conditions set from steps 118 and 123 available to the user, 125.

As described about, there are two wets of Ts&Cs that control the overall business process:

The Ts&Cs associated with the trading mechanism, such as Contract, RFQ, Auction, or Fixed Price

The Ts&Cs associated with the account.

To simplify business logic, it is possible to retrieve the entire set of Ts&Cs buy querying the trading mechanism. The following is an example:

1. Get the trading mechanism. This is either selected explicitly during the shopping flow, or is associated with the order item, RFQ, or auction that are being dealt with.

2. Retrieve the set of Ts&Cs from the trading mechanism

3. Check if the trading mechanism is associated with an account

4. If the trading mechanism is associated with an account, get the list of Ts&Cs from the account' trading object

5. If the trading mechanism is not associated with an account, get the list of accounts the user belongs to (see above for algorithm to determine list of accounts). Select the account used for this purchase if more than one are returned.

The combined set of Ts&Cs obtained in (2) and (4), or in (2) and (5) is the total set of Ts&Cs. FIG. 12 presents a flow chart depicting the process of obtaining a set of terms and conditions for a trading object. The software of the invention identifies the user and trading mechanism being used, 131; obtains a list of parent organizations of the user (to the top of the organization tree), 132; and obtains a list of the terms and conditions for the trading mechanism, 133. It then processes them and for each term or condition, obtained in step 133 determines whether the term or condition is qualified by at least one applicant, 135; if not it adds the term or condition to the result set being built up; and if so gets a list of participants that qualify the term or condition, 137. It is determined, 138, if at least one participant is an organization determined in step 132 and adds the result if affirmative to the terms and conditions result set, 139; or if not returns to perform step 134 again. Once it is finished processing these, 134, it makes the result set available to the user, 140.

Use of Trading Object during Business Process

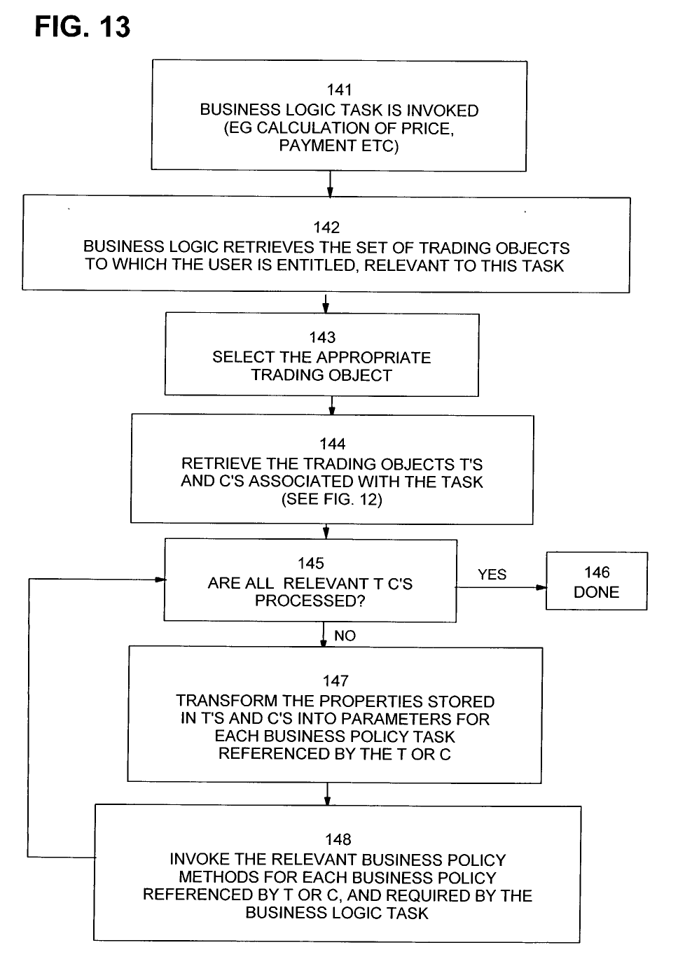

FIG. 13 presents a flow chart depicting the use of a business object during a business process.

The software of the invention is used to invoke a business logic task, eg the calculation of price, or payment, for example, 141; business logic retrieves the set of trading objects to which the user is entitled, which are relevant to this task, 142. The appropriate trading object is selected, 143, and the trading object's terms and conditions associated with the task are retrieved, 144. For all the relevant terms and conditions it transforms the properties stored in the terms and conditions into parameters for each business policy task referenced by the term or condition involved, 147, and invokes the relevant business policy methods for each business policy referenced by a term or condition, and required by the business logic task, 148. When all the relevant terms and conditions are processed, 145, the process has been completed, 146.

1. Business logic task associated with a business process is invoked

2. The business logic task retrieves the set trading objects the user qualifies for, or which the user has restricted the session to.

3. For each trading object, perform the following:

4. The business logic task retrieves of terms and conditions for the trading object

5. For each TC:

6. The business logic task transforms the properties stored in the Ts&Cs into parameters for each business policy task

7. The business logic task invokes each business policy associated with the TC.

The present invention may be embodied in other specific forms without departing from the spirit or essential characteristics thereof. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

The embodiments of the invention in which an exclusive property or privilege is claimed are defined as follows:

1. A method for implementing a unified trading structure for use in a computerized trading system that implements trading relationship mechanisms for participant roles, comprising:
selecting a set of characteristics which are common to a plurality of trading relationship mechanisms
said characteristics comprising:
identifying participants for each participant role,
terms and conditions that apply to all or selected participants,
a description of the relationship, and
storing said characteristics.

2. A method for implementing a unified trading structure in accordance with claim 1 for use in a computerized trading system that implements trading relationship mechanisms for participant roles, comprising:
selecting a set of characteristics which are common to a plurality of trading relationship mechanisms
said characteristics comprising:
identifying participants for each participant role,
terms and conditions that apply to all or selected participants, and a description of the relationship;
and at least one attachment,
storing said characteristics, and said at least one attachment.

3. The method of claim 2 wherein said characteristics of said attachment include Uniform Resource Information: mime type; and optional content.

4. A method for implementing a unified trading structure in accordance with claim 1 for use in a computerized trading system that implements trading relationship mechanisms for participant roles, comprising:
selecting a set of characteristics which are common to a plurality of trading relationship mechanisms
said characteristics comprising:
identifying participants for each participant role,
terms and conditions that apply to all or selected participants,
description of the relationship,
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions.

5. The method of claim 1 wherein said characteristics common to said terms and conditions include:
a reference to a trading object
a set of parameters
references to one more business policies such as a payment methods, qualifications, pricing formula
type and a subtype.

6. A method for implementing a unified trading structure in accordance with claim 1 for use in a computerized trading system applying business policies of participants using said trading system that implements trading relationship mechanisms for participant roles, comprising:
selecting a set of characteristics which are common to a plurality of trading relationship mechanisms
said characteristics comprising:
identifying participants,
terms and conditions that apply to all or selected participants,
description of the relationship,
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object;
wherein said characteristics common to said terms and conditions include:
references to one more business policies,
a set of trading parameters that may be used to qualify the operation of said business policies; and,
term type and where suitable, a term subtype.

7. A method for implementing a unified trading structure in accordance with claim 1 for use in a computerized trading system applying business policies of participants using said trading system that implements trading relationship mechanisms for participant roles, comprising:
selecting a set of characteristics which are common to a plurality of trading relationship mechanisms
said characteristics comprising:
identifying participants,
terms and conditions that apply to all or selected participants,
description of the relationship,
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object;
wherein said characteristics common to said terms and conditions include:
references to one more business policies,
a set of trading parameters that may be used to qualify the operation of said business policies; and,
term type and a term subtype.

8. A method for implementing a unified trading structure in accordance with claim 1 for use in a computerized trading system applying business policies of participants using said trading system that implements trading relationship mechanisms for participant roles, comprising:
selecting a set of characteristics which are common to a plurality of trading relationship mechanisms
said characteristics comprising:
identifying participants
terms and conditions that apply to all or selected participants
description of the relationship
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object;
wherein said characteristics common to said terms and conditions include:
references to one more business policies,
a set of trading parameters that may be used to qualify the operation of said business policies; and,
a term subtype, each of said subtypes being grouped with other similar subtypes, if any, into a term type.

9. The method of claim 1 in which a unified trading structure is applied to trading objects where said trading objects include contracts, RFQ's, auctions, reverse auctions and business accounts.

10. A method for determining whether a trading relationship mechanism applies to a transaction of a user, comprising:
identifying participant roles that are permitted to use said trading relationship mechanism for said transaction;
identifying participants having a set of participant characteristics with said roles in said trading relationship mechanism to which said user belongs,
if none, disallowing said transaction;
if said user belongs to at least one participant with one of said participant roles;
retrieving terms and conditions pertinent to said participants applicable to said transaction and having a set of term characteristics;
wherein said participant characteristics include:
a) identification of a participant role
b) identification of users fulfilling said participant role wherein said users may be individual participants or members of a participant organization that comprises a plurality of individuals or suborganizations or a group of users; and, optionally,
c) a reference to one or more terms and conditions
d) a reference to a trading object, and,
wherein said term characteristics common to said terms and conditions include:
references to one more business policies
a set of trading parameters that may be used to qualify the operation of said business policies; and,
term type and a term subtype.

11. A method for determining whether a trading relationship mechanism in accordance with claim 10 applies to a transaction of a user, comprising:
identifying participant roles that are permitted to use said trading relationship mechanism for said transaction;
identifying participants having a set of participant characteristics with said roles in said trading relationship mechanism to which said user belongs,
if none, disallowing said transaction;
if said user belongs to at least one participant with one of said participant roles,
retrieving terms and conditions pertinent to said participants applicable to said transaction and having a set of term characteristics;
wherein said participant characteristics include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object, and,
wherein said term characteristics common to said terms and conditions include:
references to one more business policies
a set of trading parameters that may be used to qualify the operation of said business policies; and,
a term subtype,
each of said subtypes being grouped with other similar subtypes, if any, into a term type.

12. The method of claim 1 wherein said identified participant roles may include buyers, sellers, account holders, requesters, and bidders.

13. The method of claim 12 wherein said identified participants include a set of participant characteristics.

14. The method of claim 13 wherein said set of participant characteristics may include:
a) identification of a participant role,
b) identification of a member of a participant if said participant comprises a plurality of individuals,
c) a reference to one or more terms and conditions,
d) a reference to a trading object.

15. The method of claim 9 wherein said characteristics common to a contract include
identification of participants for the buyer and seller participant roles;
terms and conditions including identification of a set of products and specifications, identification of a set of requested prices,
identification of payment terms including payment method,
identification of shipping terms,
identification of other terms and conditions;
optional reference to a business account, and,
name of contract, a description and documentation attachments as well as a description mapping relationship between specific buyer participants and selected terms and conditions.

16. The method of claim 15 wherein said contract is an unrestricted contract in which any buyer is entitled to fulfill a buyer participant role.

17. The method of claim 9 wherein said characteristics common to an RFQ include
identification of participants for the requester and seller participant roles;
terms and conditions including identification of a set of products and specifications,
identification of a set of requested prices,
identification of payment terms including payment method,
identification of shipping terms,
identification of other terms and conditions;
optional reference to a business account, and,
name of RFQ, a description and documentation attachments as well as a description mapping relationship between specific buyer participants and selected terms and conditions.

18. The method of claim 9 wherein characteristics of a business account trading object include identification of account holder and seller participants, terms and conditions including invoicing, display customization, and entitlement to unrestricted contracts as well as name of the account, and description (comments) and a documentation attachment.

19. A method in accordance with claim 10 wherein said trading object comprises a contract and a process of determining entitlement to use a contract comprises referring to the participant component of a trading object including:
finding all trading object of the type contract;
finding a list of user's parent organizations, commencing with an immediate parent and proceeding to the top level of said organization;
within said set of objects type contract, finding all contracts in which at least one said user's parent organizations located as aforesaid is a buyer participant:
within the set of all trading objects of type contract finding all unrestricted contracts which are not restricted to specific buyer participants;
finding a relevant account of said user;
verifying if said relevant account of said user allows its users to see unrestricted contracts;
if not, preventing access to said unrestricted contracts;
thereby determining a set of contracts to which a user has entitlement.

20. A method in accordance with claim 10 in which said trading object is a business account a process for determining accounts user is entitled to use comprising:
finding all trading objects of the type of account;
finding a list of the parent organizations of a user beginning a search for said parent organizations with an immediate parent and proceeding to top level organization;
from the set of accounts finding all those accounts identifying at least one said users said parent organization as an account holder participant.

21. The method of claim 1 including retrieving a set of terms and conditions associated with a trading object for a current purchasing transaction, comprising:
selecting a trading mechanism;
retrieving said set of terms and conditions of said trading mechanism;
determining if said trading mechanism is associated with an account; and,
if said trading mechanism is associated with an account, retrieving terms and conditions from the corresponding account trading object;
if said trading mechanism is not associated with an account, identifying any accounts to which said user belongs, if any accounts are identified selecting from said identified accounts an appropriate account for use for said current purchasing transaction, and retrieving terms and conditions of said selected account;
providing said retrieved terms and conditions to said user.

22. The method of claim 1 further including using a trading object for the purpose of carrying out a business process for a user, comprising:
invoking a business logic task associated with a business process:
using said business logic task to retrieve a set of trading objects to which said user is entitled access;
for each trading object performing the following procedure:
retrieving a set of terms and conditions for the trading object:
for each term or condition causing said business logic task to transform properties stored in said terms and conditions into applicable parameters for each business policy task;
causing said business logic task to invoke each business policy associated with the respected term or condition passing said applicable parameters to said business policy.

23. A method for generating provisions of a contract between a buyer and a seller on a data processing system comprising:
storing a compilation of selectable standardized trading components for generating terms and conditions of said contract;
said terms and conditions optionally referencing selectable business policies, and providing input parameters for invocation of said business policies;
said selectable business policies being adapted to use said parameters to execute business logic in accordance with appropriate terms and conditions of said contract;
wherein said selectable business policies include: pricing policies, predefined product set policies, shipping policies, payment policies, return policies, and refund policies;
said terms and conditions including the following types: product set constraints, pricing, shipping, payment, limiting, approval, return/refund, and fulfillment components.

24. The method of claim 23 wherein a pricing policy contains a method to determine standard product pricing and an adjusted price based on an input parameter.

25. The method of claim 23 wherein a predefined product set policy contains a reference to a set of products.

26. The method of claim 23 wherein a payment method policy contains payment processing methods, including methods to authorize payment, check validity of authorization, capture payment, issue refund.

27. The method of claim 26 wherein said payment method policy processes payments processes payments using a selected payment mechanism such as cheque, credit card, debit card, credit line, electronic funds transfer.

28. The method of claim 27 wherein said shipping policies include shipping mode and shipping charge policies, in which said shipping mode policy contains a reference to a shipping mode which specifies a shipping carrier and delivery priority, and said shipping charge policy contains a method to calculate a charge for shipping products to a specified location as defined by an input parameter.

29. The method of claim 23 wherein said return policies include at least one return approval policy, at least one return charge policy; and at least one refund payment method policy, wherein said return approval policy contains a method to determine whether a return authorization is to be provided for a previously purchased product; and said return charge policy contains a method to determine a refund amount for a returned product; and said refund payment method policy contains a method to issue a refund for a returned product which may be based on product payment purchase method or based on a predetermined payment method irrespective of the product payment purchase method.

30. The method of claim 23 wherein said pricing term type includes at least one pricing term of one the following subtypes:
a referenced price policy with a specified adjustment;
a referenced price policy with a specified adjustment on a selected product set;
a referenced price policy with a specified adjustment on a selected predefined product set policy;
a specified adjustment to all prices in a store customized price list in which element in said list references a product and sets the corresponding contract price for said product.

31. The method of claim 23 wherein said product set constraints, if present, include at least one product set constraint of one of the following subtypes:
include only products in a referenced product set policy;
include only products in a specified product set;
exclude all products in a referenced product set policy; and,
exclude all products in a specified product set.

32. The method of claim 23 wherein said payment method term includes a payment subtype which references a payment method policy and optionally specifies a payment instrument.

33. The method of claim 23 wherein said shipping term includes one or more shipping mode subtype, one shipping charge subtype, and optionally one or more shipping addresses; wherein said shipping mode subtype references a shipping mode policy; said shipping charge subtype references a shipping charge policy; and said shipping addresses contains the destination addresses of products purchased to be shipped.

34. The method of claim 23 wherein said return/refund term optionally includes a return term, and optionally one or more refund payment method terms, wherein said return term contains a reference to a return approval policy, and a reference to a return charge policy, and said refund payment method term contains a reference to a refund payment method policy.

35. The method of claim 23 wherein said approval term includes an optional order approval subtype containing a value which represents the value of an order, above which approval is required for orders.

36. The method of claim 23 wherein said limiting term optionally includes a right to buy subtype containing a value representing a maximum total value allowed for the sum total of all products purchased under said contract.

37. The method of claim 23 wherein said fulfillment term optionally includes one or more fulfillment center subtypes containing a name of a fulfillment center which may be used to fulfill order for products placed under said contract.

38. A method for generating provisions of a contract between a buyer and a seller on a data processing system comprising:
storing a compilation of selectable standardized trading components for generating terms and conditions of said contract;
said terms and conditions optionally referencing selectable business policies, and providing input parameters for invocation of said business policies;
said selectable business policies being adapted to use said parameters to execute business logic in accordance with appropriate terms and conditions of said contract;
wherein said selectable business policy consists of the following characteristics:
a name unique for said seller;
optional reference to a business object;
a set of predefined parameters;
a set of: method name, and reference to a corresponding task that implements the method for said policy.

39. A method for generating provisions of a business account between an account holder and a seller on a data processing system comprising:
storing a compilation of selectable standardized trading components for generating terms and conditions of said business account;
said terms and conditions optionally referencing selectable business policies, and providing input parameters for invocation of said business policies;
said selectable business policies being adapted to use said parameters to execute business logic in accordance with appropriate terms and conditions of said contract;
wherein said selectable business policies include invoice formatting policies;
said terms and conditions including the following types:
buyer purchase order, default contract entitlement, credit line, and invoice presentation.

40. The method of claim 39 wherein said invoice formatting policy contains a method to produce an invoice document.

41. The method of claim 39 wherein said purchase order type optionally includes one or more of the following subtypes:
a blanket purchase order;
a limited purchase order, and
may optionally include an individual purchase order subtype;
wherein said blanket purchase order contains a predefined allowable buyer purchase number which may be entered by a buyer when placing an order, wherein said limited purchase order contains a predefined allowable buyer purchase number and a value which represents a maximum total value of all orders which reference said limited purchase order number, and wherein said individual purchase order subtype contains indicator means indicating whether buyers can enter nonpredefined purchase order numbers when placing an order, and whether said nonpredefined purchase order numbers need to be unique for orders placed on behalf of an account.

42. The method of claim 39 wherein said default contract entitlement contains indicator means for indicating whether users of said account are entitled to use an unrestricted contract wherein said unrestricted contract is normally available for use by anyone.

43. The method of claim 39 wherein said credit line contains indicator means for indicating whether account users may use a credit line to purchase products.

44. The method of claim 39 wherein said invoice presentation contains reference to an invoice formatting policy.

45. Apparatus for implementing a unified trading structure for use in a computerized trading system that implements trading relationship mechanisms for participant roles, comprising means for:
selecting a set of characteristics which are common to a plurality of trading relationship mechanisms
said characteristics comprising:
identifying participants for each participant role,
terms and conditions that apply to all or selected participants,
a description of the relationship,
storing said characteristics.

46. Apparatus for implementing a unified trading structure in accordance with claim 45 for use in a computerized trading system that implements trading relationship mechanisms for participant roles, comprising means for:
selecting a set of characteristics which are common to a plurality of trading relationship mechanisms
said characteristics comprising:
identifying participants for each participant role,
terms and conditions that apply to all or selected participants, and a
description of the relationship;
and at least one attachment,
storing said characteristics, and said at least one attachment.

47. The apparatus of claim 46 wherein said characteristics of said attachment include Uniform Resource Information: mime type; and optional content.

48. Apparatus for implementing a unified trading structure in accordance with claim 45 for use in a computerized trading system that implements trading relationship mechanisms for participant roles, comprising means for:
selecting a set of characteristics which are common to a plurality of trading relationship mechanisms
said characteristics comprising:
identifying participants for each participant role,
terms and conditions that apply to all or selected participants,
description of the relationship,
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions.

49. The apparatus of claim 45 wherein said characteristics common to said terms and conditions include:
a reference to a trading object
a set of parameters
references to one more business policies such as a payment methods, qualifications, pricing formula
type and a subtype.

50. Apparatus for implementing a unified trading structure in accordance with claim 45 for use in a computerized trading system applying business policies of participants using said trading system that implements trading relationship mechanisms for participant roles, comprising means for:
selecting a set of characteristics which are common to a plurality of trading relationship mechanisms
said characteristics comprising:
identifying participants,
terms and conditions that apply to all or selected participants,
description of the relationship,
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object;
wherein said characteristics common to said terms and conditions include:
references to one more business policies,
a set of trading parameters that may be used to qualify the operation of said business policies; and,
term type and where suitable, a term subtype.

51. Apparatus for implementing a unified trading structure in accordance with claim 45 for use in a computerized trading system applying business policies of participants using said trading system that implements trading relationship mechanisms for participant roles, comprising means for:
selecting a set of characteristics which are common to a plurality of trading relationship mechanisms
said characteristics comprising:
identifying participants,
terms and conditions that apply to all or selected participants,
description of the relationship,
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object;
wherein said characteristics common to said terms and conditions include:
references to one more business policies,
a set of trading parameters that may be used to qualify the operation of said business policies; and,
term type and a term subtype.

52. Apparatus for implementing a unified trading structure in accordance with claim 45 for use in a computerized trading system applying business policies of participants using said trading system that implements trading relationship mechanisms for participant roles, comprising means for:
selecting a set of characteristics which are common to a plurality of trading relationship mechanisms
said characteristics comprising:
identifying participants
terms and conditions that apply to all or selected participants
description of the relationship
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object;
wherein said characteristics common to said terms and conditions include:
references to one more business policies,
a set of trading parameters that may be used to qualify the operation of said business policies; and,
a term subtype,
each of said subtypes being grouped with other similar subtypes, if any, into a term type.

53. The apparatus of claim 45 in which a unified trading structure is applied to trading objects where said trading objects include contracts, RFQ's, auctions, reverse auctions and business accounts.

54. Apparatus for determining whether a trading relationship mechanism applies to a transaction of a user, comprising means for:
identifying participant roles that are permitted to use said trading relationship mechanism for said transaction;
identifying participants having a set of participant characteristics with said roles in said trading relationship mechanism to which said user belongs,
if none, disallowing said transaction;
if said user belongs to at least one participant with one of said participant roles;
retrieving terms and conditions pertinent to said participants applicable to said transaction and having a set of term characteristics;
wherein said participant characteristics include:
a) identification of a participant role
b) identification of users fulfilling said participant role wherein said users may be individual participants or members of a participant organization that comprises a plurality of individuals or suborganizations or a group of users; and, optionally,
c) a reference to one or more terms and conditions
d) a reference to a trading object, and,
wherein said term characteristics common to said terms and conditions include:
references to one more business policies
a set of trading parameters that may be used to qualify the operation of said business policies; and,
term type and a term subtype.

55. Apparatus for determining whether a trading relationship mechanism in accordance with claim 54 applies to a transaction of a user, comprising means for:
identifying participant roles that are permitted to use said trading relationship mechanism for said transaction;
means for identifying participants having a set of participant characteristics with said roles in said trading relationship mechanism to which said user belongs,
if none, disallowing said transaction;
if said user belongs to at least one participant with one of said participant roles;
means for retrieving terms and conditions pertinent to said participants applicable to said transaction and having a set of term characteristics;
wherein said participant characteristics include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object, and,
wherein said term characteristics common to said terms and conditions include:
references to one more business policies
a set of trading parameters that may be used to qualify the operation of said business policies; and,
a term subtype,
each of said subtypes being grouped with other similar subtypes, if any, into a term type.

56. The apparatus of claim 45 wherein said identified participant roles may include buyers, sellers, account holders, requesters, and bidders.

57. The apparatus of claim 56 wherein said identified participants include a set of participant characteristics.

58. The apparatus of claim 57 wherein said set of participant characteristics may include:
a) identification of a participant role,
b) identification of a member of a participant if said participant comprises a plurality of individuals,
c) a reference to one or more terms and conditions,
d) a reference to a trading object.

59. The apparatus of claim 53 wherein said characteristics common to a contract include
identification of participants for the buyer and seller participant roles;
terms and conditions including identification of a set of products and specifications, identification of a set of requested prices,
identification of payment terms including payment method,
identification of shipping terms,
identification of other terms and conditions;
optional reference to a business account, and,
name of contract, a description and documentation attachments as well as a description mapping relationship between specific buyer participants and selected terms and conditions.

60. The apparatus of claim 59 wherein said contract is an unrestricted contract in which any buyer is entitled to fulfill a buyer participant role.

61. The apparatus of claim 53 wherein said characteristics common to an RFQ include
identification of participants for the requester and seller participant roles;
terms and conditions including identification of a set of products and specifications,
identification of a set of requested prices,
identification of payment terms including payment method,
identification of shipping terms,
identification of other terms and conditions;
optional reference to a business account, and,
name of RFQ, a description and documentation attachments as well as a description mapping relationship between specific buyer participants and selected terms and conditions.

62. The apparatus of claim 53 wherein characteristics of a business account trading object include identification of account holder and seller participants, terms and conditions including invoicing, display customization, and entitlement to unrestricted contracts as well as name of the account, and description (comments) and a documentation attachment.

63. Apparatus in accordance with claim 54 wherein said trading object comprises a contract and a process of determining entitlement to use a contract comprises referring to the participant component of a trading object including:
means for finding all trading objects of the type contract;
means for finding a list of user's parent organizations, commencing with an immediate parent and proceeding to the top level of said organization;
means for finding all contracts, within said set of objects type contract, in which at least one said user's parent organizations located as aforesaid is a buyer participant:
means for finding all unrestricted contracts within the set of all trading objects of type contract which are not restricted to specific buyer participants;
means for finding a relevant account of said user;
means for verifying if said relevant account of said user allows its users to see unrestricted contracts;
if not, preventing access to said unrestricted contracts;
thereby determining a set of contracts to which a user has entitlement.

64. An apparatus in accordance with claim 54 in which said trading object is a business account a process for determining accounts user is entitled to use comprising:
means for finding all trading objects of the type of account;
means for finding a list of the parent organizations of a user beginning a search for said parent organizations with an immediate parent and proceeding to top level organization;
means for finding all those accounts identifying at least one said users said parent organization as an account holder participant from the set of accounts.

65. The apparatus of claim 45 including retrieving a set of terms and conditions associated with a trading object for a current purchasing transaction, comprising:
means for selecting a trading mechanism;
means for retrieving said set of terms and conditions of said trading mechanism;
means for determining if said trading mechanism is associated with an account; and,
if said trading mechanism is associated with an account retrieving terms and conditions from the corresponding account trading object; if said trading mechanism is not associated with an account,
means for identifying any accounts to which said user belongs, and if any accounts are identified selecting from said identified accounts an appropriate account for use for said current purchasing transaction, and retrieving terms and conditions of said selected account; and,
means for providing said retrieved terms and conditions to said user.

66. The apparatus of claim 45 further including using a trading object for the purpose of carrying out a business process for a user, comprising:
means for invoking a business logic task associated with a business process:
means for using said business logic task to retrieve a set of trading objects to which said user is entitled access;
means for performing the following procedure for each trading object:
means for retrieving a set of terms and conditions for the trading object:
for each term or condition causing said business logic task to transform properties stored in said terms and conditions into applicable parameters for each business policy task;
means for causing said business logic task to invoke each business policy associated with the respected term or condition passing said applicable parameters to said business policy.

67. Apparatus for generating provisions of a contract between a buyer and a seller on a data processing system comprising:
means for storing a compilation of selectable standardized trading components for generating terms and conditions of said contract;
said terms and conditions optionally referencing selectable business policies, and providing input parameters for invocation of said business policies;
said selectable business policies being adapted to use said parameters to execute business logic in accordance with appropriate terms and conditions of said contract;
wherein said selectable business policies include: pricing policies, predefined product set policies, shipping policies, payment policies, return policies, and refund policies;
said terms and conditions including the following types: Product set constraints, pricing, shipping, payment, limiting, approval, return/refund, and fulfillment components.

68. The apparatus of claim 67 wherein a pricing policy contains a method to determine standard product pricing and an adjusted price based on an input parameter.

69. The apparatus of claim 67 wherein a predefined product set policy contains a reference to a set of products.

70. The apparatus of claim 67 wherein a payment method policy contains payment processing methods, including methods to authorize payment, check validity of authorization, capture payment, issue refund.

71. The apparatus of claim 70 wherein said payment method policy processes payments processes payments using a selected payment mechanism such as cheque, credit card, debit card, credit line, electronic funds transfer.

72. The apparatus of claim 71 wherein said shipping policies include shipping mode and shipping charge policies, in which said shipping mode policy contains a reference to a shipping mode which specifies a shipping carrier and delivery priority, and said shipping charge policy contains a method to calculate a charge for shipping products to a specified location as defined by an input parameter.

73. The apparatus of claim 67 wherein said return policies include at least one return approval policy, at least one return charge policy; and at least one refund payment method policy, wherein said return approval policy contains a method to determine whether a return authorization is to be provided for a previously purchased product; and said return charge policy contains a method to determine a refund amount for a returned product; and said refund payment method policy contains a method to issue a refund for a returned product which may be based on product payment purchase method or based on a predetermined payment method irrespective of the product payment purchase method.

74. The apparatus of claim 67 wherein said pricing term type includes at least one pricing term of one the following subtypes:
a referenced price policy with a specified adjustment;
a referenced price policy with a specified adjustment on a selected product set;
a referenced price policy with a specified adjustment on a selected predefined product set policy;
a specified adjustment to all prices in a store customized price list in which element in said list references a product and sets the corresponding contract price for said product.

75. The apparatus of claim 67 wherein said product set constraints, if present, include at least one product set constraint of one of the following subtypes:
include only products in a referenced product set policy;
include only products in a specified product set;
exclude all products in a referenced product set policy; and,
exclude all products in a specified product set.

76. The apparatus of claim 67 wherein said payment method term includes a payment subtype which references a payment method policy and optionally specifies a payment instrument.

77. The apparatus of claim 67 wherein said shipping term includes one or more shipping mode subtype, one shipping charge subtype, and optionally one or more shipping addresses; wherein said shipping mode subtype references a shipping mode policy; said shipping charge subtype references a shipping charge policy; and said shipping addresses contains the destination addresses of products purchased to be shipped.

78. The apparatus of claim 67 wherein said return/refund term optionally includes a return term, and optionally one or more refund payment method terms, wherein said return term contains a reference to a return approval policy, and a reference to a return charge policy, and said refund payment method term contains a reference to a refund payment method policy.

79. The apparatus of claim 67 wherein said approval term includes an optional order approval subtype containing a value which represents the value of an order, above which approval is required for orders.

80. The apparatus of claim 67 wherein said limiting term optionally includes a right to buy subtype containing a value representing a maximum total value allowed for the sum total of all products purchased under said contract.

81. The apparatus of claim 67 wherein said fulfillment term optionally includes one or more fulfillment center subtypes containing a name of a fulfillment center which may be used to fulfill order for products placed under said contract.

82. Apparatus for generating provisions of a contract between a buyer and a seller on a data processing system comprising:
means for storing a compilation of selectable standardized trading components for generating terms and conditions of said contract;
said terms and conditions optionally referencing selectable business policies, and providing input parameters for invocation of said business policies;
said selectable business policies being adapted to use said parameters to execute business logic in accordance with appropriate terms and conditions of said contract;
wherein said selectable business policy consists of the following characteristics:
a name unique for said seller;
optional reference to a business object;
a set of predefined parameters;
a set of: method name, and reference to a corresponding task that implements the method for said policy.

83. Apparatus for generating provisions of a business account between an account holder and a seller on a data processing system comprising:
means for storing a compilation of selectable standardized trading components for generating terms and conditions of said business account;
said terms and conditions optionally referencing selectable business policies, and providing input parameters for invocation of said business policies;
said selectable business policies being adapted to use said parameters to execute business logic in accordance with appropriate terms and conditions of said contract;
wherein said selectable business policies include invoice formatting policies;
said terms and conditions including the following types:
buyer purchase order, default contract entitlement, credit line, and invoice presentation.

84. The apparatus of claim 83 wherein said invoice formatting policy contains a method to produce an invoice document.

85. The apparatus of claim 83 wherein said purchase order type optionally includes one or more of the following subtypes:
a blanket purchase order;
a limited purchase order, and
may optionally include an individual purchase order subtype;
wherein said blanket purchase order contains a predefined allowable buyer purchase number which may be entered by a buyer when placing an order, wherein said limited purchase order contains a predefined allowable buyer purchase number and a value which represents a maximum total value of all orders which reference said limited purchase order number, and wherein said individual purchase order subtype contains indicator means indicating whether buyers can enter nonpredefined purchase order numbers when placing an order, and whether said nonpredefined purchase order numbers need to be unique for orders placed on behalf of an account.

86. The apparatus of claim 83 wherein said default contract entitlement contains indicator means for indicating whether users of said account are entitled to use an unrestricted contract wherein said unrestricted contract is normally available for use by anyone.

87. The apparatus of claim 83 wherein said credit line contains indicator means for indicating whether account users may use a credit line to purchase products.

88. The apparatus of claim 83 wherein said invoice presentation contains reference to an invoice formatting policy.

89. An article comprising a computer-readable signal-bearing medium for implementing a unified trading structure for use in a computerized trading system that implements trading relationship mechanisms for participant roles, comprising:
means in the medium for selecting a set of characteristics which are common to a plurality of trading relationship mechanisms
said characteristics comprising:
identifying participants for each participant role,
terms and conditions that apply to all or selected participants,
a description of the relationship,
storing said characteristics.

90. An article comprising a computer-readable signal-bearing medium for implementing a unified trading structure in accordance with claim 89 for use in a computerized trading system that implements trading relationship mechanisms for participant roles, comprising:
means in the medium for selecting a set of characteristics which are common to a plurality of trading relationship mechanisms
said characteristics comprising:
identifying participants for each participant role,
terms and conditions that apply to all or selected participants, and a
description of the relationship;
and at least one attachment,
storing said characteristics, and said at least one attachment.

91. The article comprising a computer-readable signal-bearing medium of claim 90 wherein said characteristics of said attachment include Uniform Resource Information: mime type; and optional content.

92. An article comprising a computer-readable signal-bearing medium for implementing a unified trading structure in accordance with claim 89 for use in a computerized trading system that implements trading relationship mechanisms for participant roles, comprising:
means in the medium for selecting a set of characteristics which are common to a plurality of trading relationship mechanisms
said characteristics comprising:
identifying participants for each participant role,
terms and conditions that apply to all or selected participants,
description of the relationship,
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions.

93. The article comprising a computer-readable signal-bearing medium of claim 89 wherein said characteristics common to said terms and conditions include:
a reference to a trading object
a set of parameters
references to one more business policies such as a payment methods, qualifications, pricing formula
type and a subtype.

94. An article comprising a computer-readable signal-bearing medium for implementing a unified trading structure in accordance with claim 89 for use in a computerized trading system applying business policies of participants using said trading system that implements trading relationship mechanisms for participant roles, comprising:
means in the medium for selecting a set of characteristics which are common to a plurality of trading relationship mechanisms
said characteristics comprising:
identifying participants,
terms and conditions that apply to all or selected participants,
description of the relationship,
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object;
wherein said characteristics common to said terms and conditions include:
references to one more business policies,
a set of trading parameters that may be used to qualify the operation of said business policies; and,
term type and where suitable, a term subtype.

95. An article comprising a computer-readable signal-bearing medium for implementing a unified trading structure in accordance with claim 89 for use in a computerized trading system applying business policies of participants using said trading system that implements trading relationship mechanisms for participant roles, comprising:
means in the medium for selecting a set of characteristics which are common to a plurality of trading relationship mechanisms
said characteristics comprising:
identifying participants,
terms and conditions that apply to all or selected participants,
description of the relationship,
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object;
wherein said characteristics common to said terms and conditions include:
references to one more business policies,
a set of trading parameters that may be used to qualify the operation of said business policies; and,
term type and a term subtype.

96. An article comprising a computer-readable signal-bearing medium for implementing a unified trading structure in accordance with claim 89 for use in a computerized trading system applying business policies of participants using said trading system that implements trading relationship mechanisms for participant roles, comprising:
means in the medium for selecting a set of characteristics which are common to a plurality of trading relationship mechanisms
said characteristics comprising:
identifying participants
terms and conditions that apply to all or selected participants
description of the relationship
storing said characteristics;
wherein said identified participants include a set of participants characteristics; and, wherein said set of participant characteristics may include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object;
wherein said characteristics common to said terms and conditions include:
references to one more business policies,
a set of trading parameters that may be used to qualify the operation of said business policies; and,
a term subtype,
each of said subtypes being grouped with other similar subtypes, if any, into a term type.

97. The article comprising a computer-readable signal-bearing medium of claim 89 in which a unified trading structure is applied to trading objects where said trading objects include contracts, RFQ's, auctions, reverse auctions and business accounts.

98. An article comprising a computer-readable signal-bearing medium for determining whether a trading relationship mechanism applies to a transaction of a user, comprising:
means in the medium for identifying participant roles that are permitted to use said trading relationship mechanism for said transaction;
identifying participants having a set of participant characteristics with said roles in said trading relationship mechanism to which said user belongs,
if none, disallowing said transaction;
if said user belongs to at least one participant with one of said participant roles;
retrieving terms and conditions pertinent to said participants applicable to said transaction and having a set of term characteristics;
wherein said participant characteristics include:
a) identification of a participant role
b) identification of users fulfilling said participant role wherein said users may be individual participants or members of a participant organization that comprises a plurality of individuals or suborganizations or a group of users; and, optionally,
c) a reference to one or more terms and conditions
d) a reference to a trading object, and,
wherein said term characteristics common to said terms and conditions include:
references to one more business policies
a set of trading parameters that may be used to qualify the operation of said business policies; and,
term type and a term subtype.

99. An article comprising a computer-readable signal-bearing medium for determining whether a trading relationship mechanism in accordance with claim 98 applies to a transaction of a user, comprising:
means in the medium for identifying participant roles that are permitted to use said trading relationship mechanism for said transaction;
means in the medium for identifying participants having a set of participant characteristics with said roles in said trading relationship mechanism to which said user belongs,
if none, disallowing said transaction;
if said user belongs to at least one participant with one of said participant roles;
means in the medium for retrieving terms and conditions pertinent to said participants applicable to said transaction and having a set of term characteristics;
wherein said participant characteristics include:
a) identification of a participant role,
b) identification of users fulfilling said participant role wherein said users may be individual participants or members of a participant organization that comprises a plurality of individuals or suborganizations or a group of users; and, optionally,
c) a reference to one or more terms and conditions,
d) a reference to a trading object, and,
wherein said term characteristics common to said terms and conditions include:
references to one more business policies
a set of trading parameters that may be used to qualify the operation of said business policies; and,
a term subtype,
each of said subtypes being grouped with other similar subtypes, if any, into a term type.

100. The article of claim 89 wherein said identified participant roles may include buyers, sellers, account holders, requesters, and bidders.

101. The article of claim 100 wherein said identified participants include a set of participant characteristics.

102. The article of claim 101 wherein said set of participant characteristics may include:
a) identification of a participant role,
b) identification of a member of a participant if said participant comprises a plurality of individuals,
c) a reference to one or more terms and conditions,
d) a reference to a trading object.

103. The article of claim 97 wherein said characteristics common to a contract include
identification of participants for the buyer and seller participant roles;
terms and conditions including identification of a set of products and specifications, identification of a set of requested prices,
identification of payment terms including payment method,
identification of shipping terms,
identification of other terms and conditions;
optional reference to a business account, and,
name of contract, a description and documentation attachments as well as a description mapping relationship between specific buyer participants and selected terms and conditions.

104. The article of claim 103 wherein said contract is an unrestricted contract in which any buyer is entitled to fulfill a buyer participant role.

105. The article of claim 97 wherein said characteristics common to an RFQ include
identification of participants for the requester and seller participant roles;
terms and conditions including identification of a set of products and specifications,
identification of a set of requested prices,
identification of payment terms including payment method,
identification of shipping terms,
identification of other terms and conditions;
optional reference to a business account, and,
name of RFQ, a description and documentation attachments as well as a description mapping relationship between specific buyer participants and selected terms and conditions.

106. The article of claim 97 wherein characteristics of a business account trading object include identification of account holder and seller participants, terms and conditions including invoicing, display customization, and entitlement to unrestricted contracts as well as name of the account, and description (comments) and a documentation attachment.

107. An article comprising a computer-readable signal-bearing medium in accordance with claim 98 wherein said trading object comprises a contract and a process of determining entitlement to use a contract comprises referring to the participant component of a trading object including:
means in the medium for finding all trading objects of the type contract;
means in the medium for finding a list of user's parent organizations, commencing with an immediate parent and proceeding to the top level of said organization;
means in the medium for finding all contracts, within said set of objects type contract, in which at least one said user's parent organizations located as aforesaid is a buyer participant:
means in the medium for finding all unrestricted contracts within the set of all trading objects of type contract which are not restricted to specific buyer participants;
means in the medium for finding a relevant account of said user;
means in the medium for verifying if said relevant account of said user allows its users to see unrestricted contracts;
if not, preventing access to said unrestricted contracts;
thereby determining a set of contracts to which a user has entitlement.

108. An article in accordance with claim 98 in which said trading object is a business account a process for determining accounts user is entitled to use comprising:
means in the medium for finding all trading objects of the type of account;
means in the medium for finding a list of the parent organizations of a user beginning a search for said parent organizations with an immediate parent and proceeding to top level organization;
means in the medium for finding all those accounts identifying at least one said users said parent organization as an account holder participant from the set of accounts.

109. The article of claim 89 including retrieving a set of terms and conditions associated with a trading object for a current purchasing transaction, comprising:
means in the medium for selecting a trading mechanism;
means in the medium for retrieving said set of terms and conditions of said trading mechanism;
means in the medium for determining if said trading mechanism is associated with an account; and,
if said trading mechanism is associated with an account retrieving terms and conditions from the corresponding account trading object; if said trading mechanism is not associated with an account,
means in the medium for identifying any accounts to which said user belongs, and if any accounts are identified selecting from said identified accounts an appropriate account for use for said current purchasing transaction, and retrieving terms and conditions of said selected account; and,
means in the medium for providing said retrieved terms and conditions to said user.

110. The article of claim 89 further including using a trading object for the purpose of carrying out a business process for a user, comprising:
means in the medium for invoking a business logic task associated with a business process:
means in the medium for using said business logic task to retrieve a set of trading objects to which said user is entitled access;
means in the medium for performing the following procedure for each trading object:
means in the medium for retrieving a set of terms and conditions for the trading object:
for each term or condition causing said business logic task to transform properties stored in said terms and conditions into applicable parameters for each business policy task;
means in the medium for causing said business logic task to invoke each business policy associated with the respected term or condition passing said applicable parameters to said business policy.

111. An article comprising a computer-readable signal-bearing medium for generating provisions of a contract between a buyer and a seller on a data processing system comprising:
means in the medium for storing a compilation of selectable standardized trading components for generating terms and conditions of said contract;
said terms and conditions optionally referencing selectable business policies, and providing input parameters for invocation of said business policies;
said selectable business policies being adapted to use said parameters to execute business logic in accordance with appropriate terms and conditions of said contract;
wherein said selectable business policies include: pricing policies, predefined product set policies, shipping policies, payment policies, return policies, and refund policies;
said terms and conditions including the following types: product set constraints, pricing, shipping, payment, limiting, approval, return/refund, and fulfillment components.

112. The article of claim 111 wherein a pricing policy contains a method to determine standard product pricing and an adjusted price based on an input parameter.

113. The article of claim 11 wherein a predefined product set policy contains a reference to a set of products.

114. The article of claim 111 wherein a payment method policy contains payment processing methods, including methods to authorize payment, check validity of authorization, capture payment, issue refund.

115. The article of claim 114 wherein said payment method policy processes payments processes payments using a selected payment mechanism such as cheque, credit card, debit card, credit line, electronic funds transfer.

116. The article of claim 115 wherein said shipping policies include shipping mode and shipping charge policies, in which said shipping mode policy contains a reference to a shipping mode which specifies a shipping carrier and delivery priority, and said shipping charge policy contains a method to calculate a charge for shipping products to a specified location as defined by an input parameter.

117. The article of claim 111 wherein said return policies include at least one return approval policy, at least one return charge policy; and at least one refund payment method policy, wherein said return approval policy contains a method to determine whether a return authorization is to be provided for a previously purchased product; and said return charge policy contains a method to determine a refund amount for a returned product; and said refund payment method policy contains a method to issue a refund for a returned product which may be based on product payment purchase method or based on a predetermined payment method irrespective of the product payment purchase method.

118. The article of claim 111 wherein said pricing term type includes at least one pricing term of one the following subtypes:
a referenced price policy with a specified adjustment;
a referenced price policy with a specified adjustment on a selected product set;
a referenced price policy with a specified adjustment on a selected predefined product set policy;
a specified adjustment to all prices in a store customized price list in which element in said list references a product and sets the corresponding contract price for said product.

119. The of claim 111 wherein said product set constraints, if present, include at least one product set constraint of one of the following subtypes:
include only products in a referenced product set policy;
include only products in a specified product set;
exclude all products in a referenced product set policy; and,
exclude all products in a specified product set.

120. The of claim 111 wherein said payment method term includes a payment subtype which references a payment method policy and optionally specifies a payment instrument.

121. The article of claim 111 wherein said shipping term includes one or more shipping mode subtype, one shipping charge subtype, and optionally one or more shipping addresses; wherein said shipping mode subtype references a shipping mode policy; said shipping charge subtype references a shipping charge policy; and said shipping addresses contains the destination addresses of products purchased to be shipped.

122. The article of claim 111 wherein said return/refund term optionally includes a return term, and optionally one or more refund payment method terms, wherein said return term contains a reference to a return approval policy, and a reference to a return charge policy, and said refund payment method term contains a reference to a refund payment method policy.

123. The article of claim 111 wherein said approval term includes an optional order approval subtype containing a value which represents the value of an order, above which approval is required for orders.

124. The article of claim 111 wherein said limiting term optionally includes a right to buy subtype containing a value representing a maximum total value allowed for the sum total of all products purchased under said contract.

125. The article of claim 111 wherein said fulfillment term optionally includes one or more fulfillment center subtypes containing a name of a fulfillment center which may be used to fulfill order for products placed under said contract.

126. An article comprising a computer-readable signal-bearing medium for generating provisions of a contract between a buyer and a seller on a data processing system comprising:
means in the medium for storing a compilation of selectable standardized trading components for generating terms and conditions of said contract;
said terms and conditions optionally referencing selectable business policies, and providing input parameters for invocation of said business policies;
said selectable business policies being adapted to use said parameters to execute business logic in accordance with appropriate terms and conditions of said contract;
wherein said selectable business policy consists of the following characteristics:
a name unique for said seller;
optional reference to a business object;
a set of predefined parameters;
a set of: method name, and reference to a corresponding task that implements the method for said policy.

127. An article comprising a computer-readable signal-bearing medium for generating provisions of a business account between an account holder and a seller on a data processing system comprising:
means in the medium for storing a compilation of selectable standardized trading components for generating terms and conditions of said business account;
said terms and conditions optionally referencing selectable business policies, and providing input parameters for invocation of said business policies;
said selectable business policies being adapted to use said parameters to execute business logic in accordance with appropriate terms and conditions of said contract;
wherein said selectable business policies include invoice formatting policies;
said terms and conditions including the following types:
buyer purchase order, default contract entitlement, credit line, and invoice presentation.

128. The article of claim 127 wherein said invoice formatting policy contains a method to produce an invoice document.

129. The article of claim 127 wherein said purchase order type optionally includes one or more of the following subtypes:
a blanket purchase order;
a limited purchase order, and
may optionally include an individual purchase order subtype;
wherein said blanket purchase order contains a predefined allowable buyer purchase number which may be entered by a buyer when placing an order, wherein said limited purchase order contains a predefined allowable buyer purchase number and a value which represents a maximum total value of all orders which reference said limited purchase order number, and wherein said individual purchase order subtype contains indicator means indicating whether buyers can enter nonpredefined purchase order numbers when placing an order, and whether said nonpredefined purchase order numbers need to be unique for orders placed on behalf of an account.

130. The article of claim 127 wherein said default contract entitlement contains indicator means in the medium for indicating whether users of said account are entitled to use an unrestricted contract wherein said unrestricted contract is normally available for use by anyone.

131. The article of claim 127 wherein said credit line contains indicator means in the medium for indicating whether account users may use a credit line to purchase products.

132. The article of claim 127 wherein said invoice presentation contains reference to an invoice formatting policy.

133. The article of claims 89, 98, 111, 126, or 127 wherein the medium is selected from the group consisting of electronic, magnetic, optical, biological, atomic data storage media, a modulated carrier signal, a modulated carrier signal comprising a transmission over the Internet

134. A computer program comprising computer program code means adapted to perform all the steps of claims 89 to 133 when said program is run on a computer.

135. The article of claims 89 to 133 wherein said means in the mechanism comprises computer program code.
